(19) United States
(12) Patent Application Publication
(10) Pub. No.: US 2021/0258496 A1
(43) Pub. Date: Aug. 19, 2021

(54) IMAGE PROCESSING DEVICE, IMAGE PROCESSING SERVER, IMAGE PROCESSING METHOD, AND STORAGE MEDIUM

(71) Applicant: CANON KABUSHIKI KAISHA, Tokyo (JP)

(72) Inventors: Takehiro Yoshida, Tokyo (JP); Yusuke Shirakawa, Kanagawa (JP); Yusuke Haruyama, Tokyo (JP)

(21) Appl. No.: 17/307,582

(22) Filed: May 4, 2021

Related U.S. Application Data
(63) Continuation of application No. PCT/JP2019/040874, filed on Oct. 17, 2019.

(30) Foreign Application Priority Data
Nov. 7, 2018 (JP) 2018-209469
Nov. 7, 2018 (JP) 2018-209480
Nov. 7, 2018 (JP) 2018-209494

(51) Int. Cl. H04N 5/232; G06K 9/46; H04N 5/235

(52) U.S. Cl. CPC H04N 5/23299; H04N 5/232939; H04N 5/23218; H04N 5/232125; G06K 9/4661; H04N 5/2353; G06K 9/4652

(57) ABSTRACT

When a professional cameraman or general spectator acquires a video, position information of a specific target can be displayed in a timely manner.

An image processing device includes a display unit for displaying an image, a selection unit for selecting a specific target from the image displayed on the display unit, a specification information generation unit for generating specification information of the specific target selected by the selection unit, a transmission unit for transmitting the specification information to a server, an acquisition unit for acquiring position information of the specific target based on the specification information from the server, and a control unit for causing the display unit to display additional information based on the position information of the specific target acquired by the acquisition unit.

### CROSS-REFERENCE OF RELATED APPLICATIONS

This application is a continuation of International Patent Application No. PCT/JP2019/040874, filed on Oct. 17, 2019, which claims the benefit of Japanese Patent Application Nos. 2018-209469, 2018-209480, and 2018-209494, filed on Nov. 7, 2018, all of which are hereby incorporated by reference herein their entirety.

### BACKGROUND

### Field

The present embodiment relates to an image processing device, and the like for photographing and video monitoring.

As internationalization has progressed in recent years, many tourists have been visiting Japan. In addition, the number of opportunities to photograph sport players from various countries has remarkably increased in sporting games.

However, it is relatively difficult for professional cameramen and ordinary people who take photos to find a specific player among many players, for example, in scenes of sporting games.

In addition, movements are fast during games and multiple players cross over particularly in sporting games, and thus locations of players are often lost to sight. This is not limited to sporting games, and the same situation likewise happens when a specific person, or the like is being photographed or monitored in a crowd.

Japanese Unexamined Patent Application Publication No. 2017-211828 discloses multiple cameras for photographing a subject from multiple directions and multiple image processing devices that extract a predetermined region from an image captured by a corresponding camera among the multiple cameras. In addition, an image generation device that generates a virtual viewpoint image based on image data of predetermined regions extracted by the multiple image processing devices from images captured by the multiple cameras is also disclosed.

Japanese Patent No. 5322629 discloses an auto-focus detection device that drives a focus lens based on an AF evaluation value acquired from a captured image and controls auto-focus detection.

However, in a case of sports scenes in which many players have gathered, or the like, players may overlap or may be lost to sight. In addition, players may be out of sight, and it is more difficult to photograph a player at a suitable timing.

Furthermore, although professional cameramen may be particularly required to immediately send captured photos to newsrooms, or the like, unless they quickly understand the results of judgement by a referee, it takes time to recognize the judgement, which is a disadvantage.

Furthermore, even if a cameraman finds a player who he or she desires to photograph, the cameraman needs to track the player who he or she desires to photograph even after focusing on the player. Such tracking is very difficult in sports involved with fast movements, and if a cameraman concentrates on the tracking, good photos may not be able to be taken, which is a disadvantage.

In addition, although omnidirectional videos and various kinds of information of the fields of games and matches can be ascertained and various kinds of valuable information inside and outside of the ground can also be obtained on the server side, there is a problem for a conventional system that servers are not sufficiently utilized.

Likewise, there are many cases in which ordinary users who are monitoring games in arenas or with terminals in their homes may lose sight of a specific player or fail to keep up with the situation of a game. Likewise, in car racing, air racing, horse racing, or the like, a target such as a specific car, airplane, horse, or the like may be lost to sight. Furthermore, in a case in which a specific person is tracked on a street corner, the specific person may become lost in the crowd.

In addition, in such a case in which a person concentrates on visually tracking a specific target of interest, there is a problem that photographing, focusing, exposure adjustment, and the like with respect to the target may not be able to be smoothly performed.

There is a need in the art to solve the above-described problems and to provide an image processing device that can provide timely display of useful information to photographers and observers.

### SUMMARY

According to an embodiment of the present disclosure, there is provided an image processing device that includes:

a display unit configured to display an image,

a selection unit configured to select a specific target from the image displayed on the display unit,

a specification information generation unit configured to generate specification information of the specific target selected by the selection unit, a transmission unit configured to transmit the specification information generated by the specification information generation unit to a server, an acquisition unit configured to acquire position information of the specific target based on the specification information from the server, and a control unit configured to cause the display unit to display additional information based on the position information of the specific target acquired by the acquisition unit.

Further features of the present disclosure will become apparent from the following description of exemplary embodiments with reference to the attached drawings.

### BRIEF DESCRIPTION OF DRAWINGS

FIG. 1 is a diagram schematically illustrating a configuration of a system using an image processing device of an embodiment.

FIG. 2 is a detailed block diagram of a server side.

FIG. 3 is a detailed block diagram of a terminal side.

FIG. 4 is a detailed block diagram of the terminal side.

FIG. 5A illustrates a sequence in which the server 110 side answers to a question (request) of the camera 500 side. FIG. 5B illustrates another player-of-interest display start sequence.

FIG. 6A illustrates a flow where the camera 500 periodically makes inquiries (requests) to the server 110 to continuously check a position of a player. FIG. 6B illustrates a flow where ID information of the player of interest is sent from the camera 500 to the server 110 and position information of the player of interest is first acquired from the server.

FIG. 7A illustrates a flow where the camera 500 further tracks the player of interest by itself through image recognition. FIG. 7B illustrates a flow where the server 110 further predicts that the camera 500 has a high likelihood of losing the player of interest.

FIG. 8A is a diagram illustrating a player-of-interest display tracking control flow of a camera side. FIG. 8B illustrates a flow of S107-2 for displaying a mark.

FIG. 9 is a diagram illustrating another example of the player-of-interest display tracking control flow of the camera side.

FIG. 10 is a block diagram illustrating a functional configuration example of a tracking unit 371 of a digital camera.

FIG. 11 is a diagram illustrating a player-of-interest detection control flow of a server side.

FIG. 12 is a diagram illustrating a flow of detecting the uniform number of a player on the server side.

FIG. 13 is a diagram illustrating another example of the player-of-interest detection control flow of the server side.

FIG. 14 is a diagram illustrating another example of the player-of-interest detection control flow of the server side.

FIG. 15 is a diagram illustrating another example of the player-of-interest detection control flow of the server side.

FIG. 16 is a diagram illustrating another example of the player-of-interest detection control flow of the server side.

FIG. 17A illustrates an example of display of position information of the player of interest in videos of the display unit of a camera. FIG. 17B illustrates a case where an oblique upper-rightward arrow is displayed near a place in the oblique upper-right direction on the screen. FIG. 17C is a diagram illustrating an example in which directions and lengths of arrows are displayed to indicate a direction and a degree in which the camera needs to move to place the player of interest in the photographing area. FIG. 17D is a diagram illustrating an example in which a thickness of an arrow is changed while keeping a length of the arrow constant.

FIG. 18 is a diagram illustrating another example of the player-of-interest display tracking control flow of the camera side.

FIG. 19 is a diagram illustrating another example of the player-of-interest display tracking control flow of the camera side.

FIG. 20 is a diagram illustrating another example of the player-of-interest display tracking control flow of the camera side.

FIG. 21 is a diagram illustrating another example of the player-of-interest display tracking control flow of the camera side.

FIG. 22 is a diagram illustrating a player's foul detection flow of the server side.

FIG. 23 is a diagram illustrating a try judgment control flow of the server side.

FIG. 24A illustrates a flow of determining the presence or absence of a try on the server side using motions of the ball. FIG. 24B illustrates a try presence/absence judgment flow based on an action of the referee.

FIG. 25A Illustrates a try presence/absence judgment flow based on a judgment result of the server side displayed on the screen. FIG. 25B illustrates a try presence/absence recognition flow based on scoring information displayed on the screen.

FIG. 26 is a diagram illustrating a try judgment flow from audio information.

FIG. 27 is a diagram illustrating a try judgment control flow of a camera side.

FIG. 28 is a diagram illustrating a player's foul judgment control flow of the server side.

FIG. 29A illustrates an example of a player's foul judgment flow of the server side based on an action of the referee. FIG. 29B illustrates a player's foul judgment flow of the server side based on audio information.

FIG. 30 is a diagram illustrating a foul judgment flow of the camera side.

FIGS. 31A and 31B illustrate actions of a referee who is judging a try. FIG. 31A illustrates an action of the referee taken when a try is successful. FIG. 31B illustrates an action of the referee taken when a try is not successful.

FIG. 32 is a diagram illustrating an example of a detection control flow for a player-of-interest including reserves.

FIG. 33 is a diagram illustrating an example of a player-of-interest detection control flow.

FIGS. 34A and 34B are diagrams illustrating AF display examples of a camera display unit for a player of interest. FIG. 34 illustrates a situation where a player of interest is committing handoff. FIG. 34B illustrates a situation where auto-focusing (AF) is performed on the player of interest.

FIG. 35 is a diagram illustrating an example of a player-of-interest detection control and AF flow.

FIG. 36 is a diagram illustrating another example of the player-of-interest detection control and AF flow.

FIGS. 37A and 37B are diagrams illustrating display examples of the camera display unit at the time of auto-tracking. FIG. 37A illustrates a situation where seven players including A, B, C, D, E, F, Q and H are placed in the photographing area of the camera. FIG. 37B illustrates a zoom-out state of the display unit of the camera when the auto-tracking mode is turned on.

FIGS. 38A and 38B are diagrams illustrating display examples of the camera display unit for a player of interest at the time of auto-tracking. FIG. 38A illustrates a situation where the player of interest being outside of the display screen is indicated by an arrow. FIG. 38B illustrates a situation where an arrow indicates the position of the player of interest in the screen.

FIG. 39 is a diagram illustrating an example of a player-of-interest detection control flow at the time of auto-tracking.

FIG. 40 is a diagram illustrating the example of the player-of-interest detection control flow at the time of auto-tracking.

FIG. 41 is a diagram illustrating an example of a player-of-interest change detection control flow.

FIG. 42 is a diagram illustrating the example of the player-of-interest change detection control flow.

FIG. 43 is a diagram illustrating an example of a reserve player recognition control flow.

### DESCRIPTION OF THE EMBODIMENTS

Hereinafter, preferable modes for implementing the present disclosure will be described using embodiments.

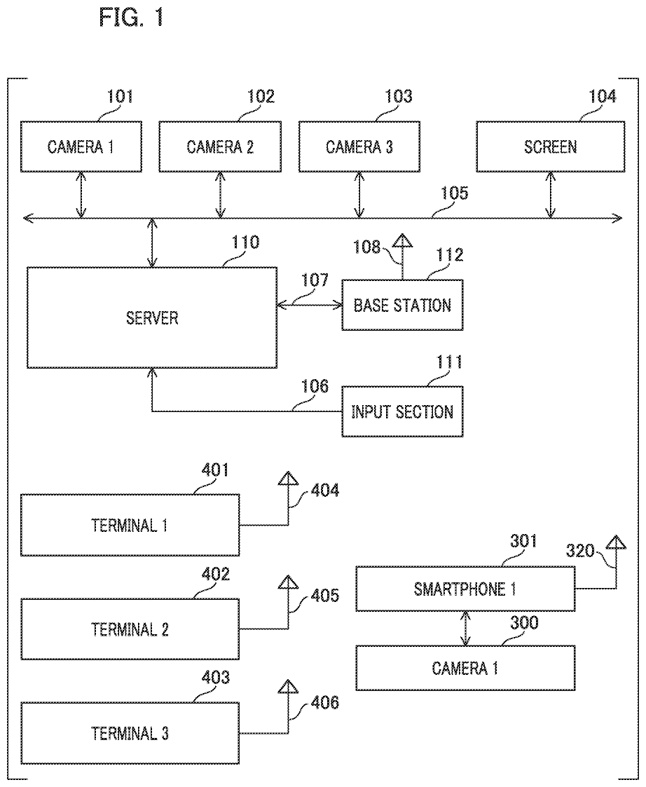

First, an overview of a system using an image processing device to support photographing and video monitoring will be described using FIG. 1.

In FIG. 1, the server (an image processing server) side with multiple cameras (fixed cameras or mobile cameras using drones, or the like) for servers keeps track of a position of a player of interest (a specific target) in the entire field of an arena and the latest status of the game in real time. In addition, an example in which the server provides information necessary for, for example, camera shooting or image monitoring to terminals carried by individual spectators is illustrated in a timely manner.

Generally, professional cameramen and normal photographers may have a location at which they cannot recognize or track at an angle or in the field of view that they are capturing with cameras. The same applies to spectators who are positioned outside the area and not performing imaging. In contrast, the server-side system can ascertain omnidirectional videos and information of the entire field of match (coordinate information and the like of the field) in advance based on videos from a plurality of cameras for the server and perform mapping.

Thus, information that is hard for individual users to see and understand can be ascertained and distributed by the server to dramatically improve services for the spectators.

In other words, it is possible to keep track of a position, scores, fouls, judgment results of the referee, and other latest status with respect to each player using multiple cameras for the server (fixed cameras and mobile cameras). In addition, the data can be analyzed by the server based on the information displayed on a large-sized screen, or the like. Thus, it is possible to accurately recognize the whole situation and transmit the information to terminals like camera terminals, smartphones, tablets, and the like possessed by professional cameramen and spectators in a timely manner.

As a result, the spectators can ascertain the latest situation of the game in a timely manner. Particularly, although professional cameramen are required to send captured photos to a newsroom or the like promptly, it is difficult for them to accurately ascertain the entire situation of the game, and the like simply by viewing the screens of cameras because the field of view is relatively small.

However, situations of games and the like can be swiftly understood if the configuration of this embodiment is used, and a photo to be sent to the newsroom and the like can be quickly selected.

Further, as terminals (image processing devices) used by professional cameramen and spectators, digital cameras, smartphones, a configuration in which a camera, a smartphone, and the like are connected, tablet PCs or TVs, and the like are conceivable. The same service can be provided to viewers who are watching games at home using their terminals (image processing devices) such as PCs, TVs, and the like through the Internet or TV broadcasting, and thus the viewers can ascertain situations of the games more accurately and enjoy the games with more fun.

In FIG. 1, 101 to 103 denote cameras for a server, and 101 (a fixed camera 1), 102 (a fixed camera 2), 103 (a fixed camera 3), 104 (a large screen), 110 (a server), 111 (an input section), and 112 (a base station) perform video acquisition, audio acquisition, and the like for providing information to general professional cameramen and spectators. Although the number of cameras for the server is three including cameras 101 to 103 in the present embodiment, one or multiple cameras are possible. In addition, these cameras for the server may not be fixed cameras, and may be, for example, cameras mounted in a drone, or the like. In addition to the video acquisition and audio acquisition, input information (e.g., audio information, etc.) other than videos can also be input from the input section to expand services to general professional cameramen, spectators, and the like.

105 denotes a wired or wireless LAN or the Internet, and 106 denotes a connection line for inputting information output from the input section 111 as an input unit to the server 110. 107 denotes a connection line for transmitting and receiving a signal to and from the base station 112, and 108 denotes an antenna unit of the base station for performing wireless communication.

In other words, the blocks in the number of 100s described above are ones for supporting professional cameramen, general spectators, and the like for capture of videos, and the like.

Meanwhile, in FIG. 1, 401 (a terminal 1), 402 (a terminal 2), and 403 (a terminal 3) denote terminals, and for example, video display terminal devices, for example, cameras, smartphones, tablet PCs, TVs, and the like for professional cameramen and spectators to perform photographing and monitoring. Here, 404 (an antenna), 405 (an antenna), and 406 (an antenna) denote antennas of 401 (the terminal 1), 402 (the terminal 2), and 403 (the terminal 3) for performing wireless communication, respectively.

When the server detects a position of a player of interest, for example, ID information, or the like of the player of interest is transmitted from a terminal to the server side, and various kinds of information such as position information regarding the player is sent from the server side to the terminal. A process of detecting the player of interest needs to be performed in a short period of time because the player is moving and the situation of the game is changing. Thus, the wireless communication in this case uses, for example, 5G, or the like.

Further, 401 (the terminal 1), 402 (the terminal 2), and 403 (the terminal 3) may have a configuration in which a camera, a smartphone, and the like are connected in combination. In the lower right side of FIG. 1, 301 denotes a smartphone which mainly controls communication with the server. In addition, if application software is installed in this smartphone, various kinds of video acquisition service can be realized. In addition, 300 denotes a (digital) camera, which is an image processing device that allows a professional cameraman or a spectator to perform photographing or monitor images. Here, the camera 300 is connected to the smartphone 301 through a USB or Bluetooth (a registered trademark). 320 denotes an antenna of the smartphone 301 for performing wireless communication with the base station 112.

Further, although the terminal exchanges videos and control signals with the server in a wireless manner if the terminal is a smartphone, or the like, a connection to perform communication with a terminal may be adaptively used in wireless communication and wired communication. A connection can be controlled such that, for example, wireless communication is performed if the wireless communication environment is 5G, wired communication is performed for information with a large amount of data if the wireless communication environment is LTE, and wireless communication is performed for a control signal with a small amount of data. Furthermore, a connection can be switched to wired communication depending on the congestion degree of the wireless communication line.

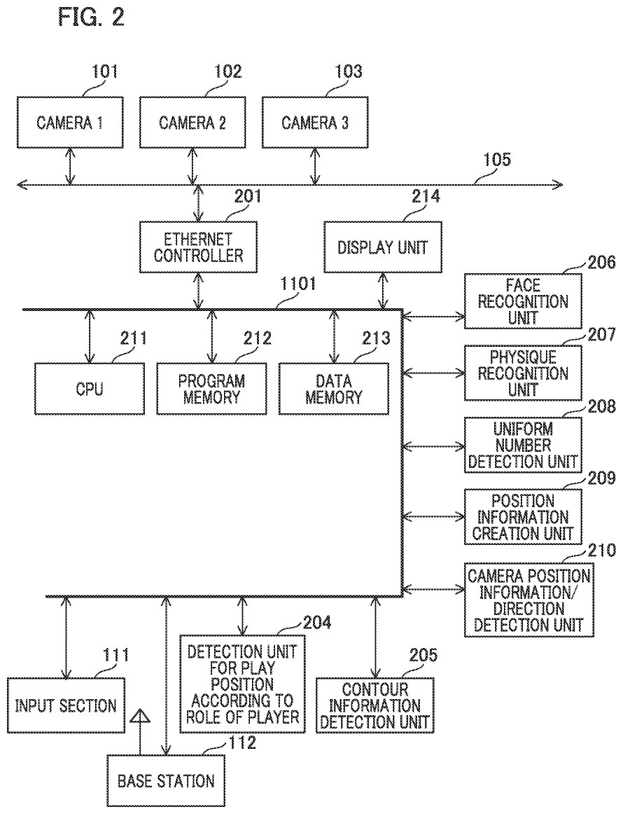

Next, a block configuration of the server side will be described in detail using FIG. 2. Reference numerals in FIG. 2 the same as those in FIG. 1 represent the same constituents, and description thereof will be omitted.

201 denotes an Ethernet (a registered trademark) controller, and 204 denotes a detection unit that detects a play position according to the role (so-called position) of a player. Here, the role (position) of a player is set through registration, or the like, in advance.

As the roles (positions) in rugby, for example, 1 and 3 are called a prop, 2 is called a hooker, 4 and 5 are called a lock, 6 and 7 are called a flanker, 8 is called a number—8, 9 is called a scrum-half, and 10 is called a standoff. In addition, 11 and 14 are called a wing, 12 and 13 are called a center, and 15 is called a fullback.

For positions of the players, forwards are located in the front of the attack, and backs are located behind the attack often at the time of a set play, or the like.

In other words, since a rough position of a player is decided according to the role (position) of the player, the player of interest can be tracked effectively with accuracy by knowing the role (position) of the player of interest and tracking the player.

Further, the role of the player is often able to be recognized by the uniform number. However, the player of No. 10 may be injured, the player of No. 15 may be in a standoff (have gone to the position of the player of No. 10), and a reserve player may go to the position of the player of No. 15 in a case.

Here, the uniform number of the reserve player may be any one from 16 to 23. However, the position is not confirmed only with the uniform number at all times. Thus, although the detection unit 204 detects a play position according to the pre-set role of the player and information of the detected play position is input to a CPU 211 in the server 110, the pre-set role may be changed due to a substitution of a player during a game, or the like.

205 denotes a contour information detection unit, and when professional cameramen and spectators capture videos at their positions and angles with a magnification of the cameras while monitoring the videos using their terminals, for example, the server 110 notifies each of the terminals 401 to 403, or the like of the position of the player of interest. In addition, when the server 110 notifies each of the terminals 401 to 403, or the like of contour information of the player of interest being photographed, each of the terminals 401 to 403 can recognize the player of interest more reliably. The contour information detected by the block of 205 is taken to the CPU 211.

206 denotes a player face recognition unit, which finds a player from videos based on face photo information of the player of interest that has been registered in advance using AI, particularly, an image recognition technology such as deep learning. Information of the face recognition result detected by the face recognition unit 206 is input to the CPU 211.

207 denotes a physique recognition unit for players, which finds a player of interest based on physique photo information of the player registered in advance using the above-described image recognition technology.

208 denotes a uniform number detection unit for players, which finds a player of interest based on the number (uniform number, or the like) registered in advance using the above-described image recognition technology. Further, it is needless to say that, when the number of a player is to be detected, not only the number on the back side of a bib but also the number on the front side may be detected. 209 denotes a position information creation unit, which recognizes a position, a direction, and an angle of view of each camera from position information of the cameras 101, 102, and 103 obtained using a GPS and information regarding the direction and angle of view of the cameras. In addition, information of an absolute position of a player on the ground is acquired based on a video from each of the cameras using the triangulation method.

The position information creation unit 209 may acquire a position of a pole, a line of the field of a game (e.g., a side line or an end line), and the like on a screen from a video as a reference index for reference position detection installed in advance in the arena. Then, an absolute position of the player of interest on the field in the arena may be acquired using the pole, line, and the like as reference coordinates.

210 denotes a camera position information/direction detection unit that detects a position of each terminal, a direction and an angle of view in and at which the camera of each terminal faces from position information, direction information, and angle-of-view information of each terminal transmitted from each of the terminals 401 to 403.

211 denotes a central processing unit (CPU) functioning as a computer, which is a central arithmetic processing device that performs control introduced in the following examples based on a computer program for control stored in a program memory 212 functioning as a storage medium. In addition, the CPU also serves as a display control unit which controls information to be displayed on a display unit 214 which will be described below. 213 denotes a data memory that stores various kinds of data referred to by the CPU 211.

The data memory 213 stores information of past matches, information of past players, information regarding today's match (game), information regarding the number of spectators, weather, and the like, information of players of interest, the current situation of players, and the like. The information of players of interest includes information of their faces, uniform numbers, physiques, and the like. 1101 denotes a data bus line inside the server 110.

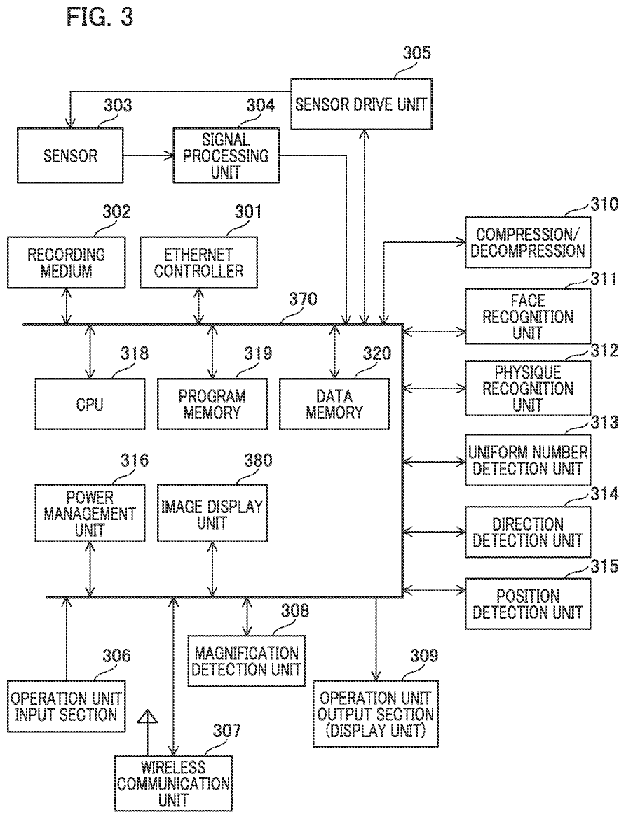

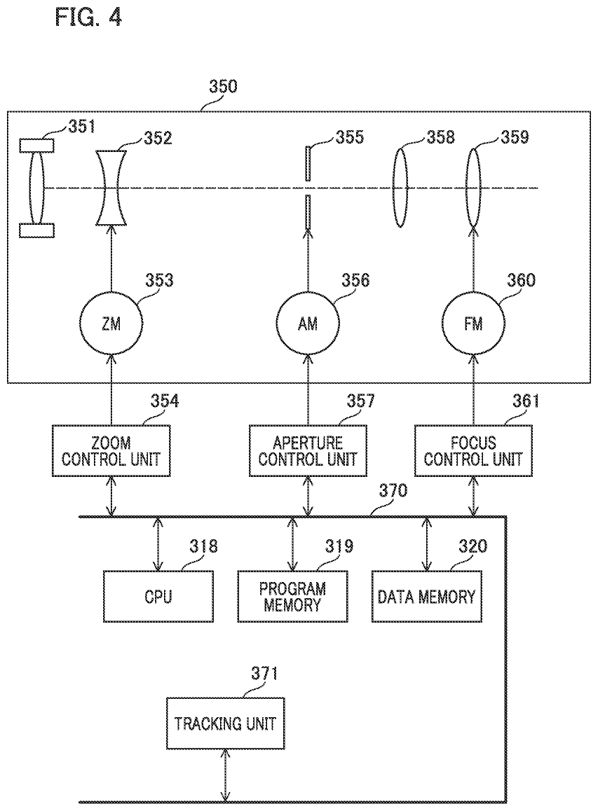

Next, the terminal side functioning as an image processing device will be described in detail using FIGS. 3 and 4. FIGS. 3 and 4 are block diagrams illustrating a configuration example of a terminal, illustrating an entire configuration of a digital camera 500 as an example of the terminal using the two drawings.

The digital camera illustrated in FIGS. 3 and 4 can capture moving images and still images and record information of this capture.

In addition, although a central processing unit (CPU) 318, a program memory 319, and a data memory 320 are illustrated both in FIGS. 3 and 4, each of the units are the same block, and only one CPU, program memory, and data memory are included.

In FIG. 3, 301 denotes an Ethernet (a registered trademark) controller. 302 denotes a storage medium, which stores moving images and still images captured using the digital camera in a predetermined format.

303 denotes an image sensor functioning as an image device such as a CCD or a CMOS, which converts an optical signal of an optical image to an electrical signal and further converts analog information of the information of the image to digital data and outputs the data. 304 denotes a signal processing unit, which performs various kinds of correction such as white balancing correction or gamma correction on the digital data output from the image sensor 303 and outputs the corrected data. 305 denotes a sensor drive unit, which drives horizontal/vertical lines for reading information from the image sensor 303 and controls a timing at which the image sensor 303 outputs the digital data, or the like.

306 denotes an operation unit input section. Input is performed by selecting or setting various conditions for photographing with the digital camera, or according to a triggering operation for photographing, a selection operation for using the flash, an operation of changing a battery, or the like. In addition, the operation unit input section 306 can select/set whether a player of interest is to be auto-focused (AF) based on position information from the server. Information for selecting/setting whether the player of interest is to be auto-focused (AF) is output from the operation unit input section 306 to a bus line 370.

Furthermore, the operation unit input section 306 can select/set whether a player of interest is to be automatically tracked based on position information from the server. Information of which player is to be designated as a player of interest (specific target), whether auto-tracking of a player of interest is to be performed based on position information from the server, and the like is generated by the operation unit input section 306 functioning as a selection unit. In other words, the operation unit input section 306 functions as a specification information generation unit that generates specification information regarding a specific target.

307 denotes a wireless communication unit that functions as a transmission/reception unit to cause a camera terminal possessed by a professional cameraman, a general spectator, or the like to communicate with the server side wirelessly. 308 denotes a magnification detection unit that detects a photographing magnification of the digital camera.

309 denotes an operation unit output section for displaying UI information such as a menu or setting information on an image display unit 380 that displays information captured by the digital camera, and the like. 310 denotes a compression/decompression circuit, and digital data (raw data) from the image sensor 303 is developed by the signal processing unit 304, and the compression/decompression circuit 310 converts the data into a JPEG image file or an HEIF image file or compresses the data into raw data without change to make it as a raw image file.

Meanwhile, when a raw image file is developed in a camera to generate a JPEG image file or an HEIF image file, a process of decompressing compressed information to return the file to raw data is performed.

311 denotes a face recognition unit, which refers to face photo information of a player of interest registered in the server in advance to find the player from videos through image recognition using AI, particularly, a technique of deep learning, or the like. Information regarding a recognition result of a face detected by the face recognition unit 311 is input to the CPU 318 via the bus line 370.

312 denotes a physique recognition unit, which refers to physique photo information of the player of interest registered in the server in advance to find the player of interest from videos using the above-described image recognition technique.

313 denotes a player uniform number detection unit, which finds a player of interest with the uniform number (the front number is also possible) of the player using the above-described image recognition technique. 314 denotes a direction detection unit that detects a direction in which the lens of the terminal faces. 315 denotes a position detection unit that detects position information of the terminal using, for example, the GPS, or the like.

316 denotes a power management unit that detects a state of power of the terminal and supplies power to the entire terminal after detecting the pressed power button with the power switch off 318 denotes a CPU functioning as a computer, which performs control introduced in the following examples based on a computer program for control stored in the program memory 319 functioning as a storage medium.

In addition, the CPU also serves as a display control unit which controls image information to be displayed on the image display unit 380. Further, the image display unit 380 is a display unit using liquid crystal, organic EL, or the like.

The data memory 320 stores setting conditions of the digital camera, and stores captured still images and moving images and further attribute information of still images and moving images, and the like.

In FIG. 4, 350 denotes a photographing lens unit, including a first fixed group lens 351, a zoom lens 352, an aperture 355, a third fixed group lens 358, a focus lens 359, a zoom motor 353, an aperture motor 356, and a focus motor 360. The first fixed group lens 351, the zoom lens 352, the aperture 355, the third fixed group lens 358, and the focus lens 359 constitute a photographing optical system. Further, although each of the lenses 351, 352, 358, and 359 is illustrated as one lens, these may include multiple lenses.

In addition, the photographing lens unit 350 may be configured as an interchangeable lens unit that is detachable from the digital camera.

A zoom control unit 354 controls operations of the zoom motor 353 and changes a focal distance (angle of view) of the photographing lens unit 350. An aperture control unit 357 controls operations of the aperture motor 356 and changes an opening diameter of the aperture 355.

A focus control unit 361 calculates an amount of defocusing and a direction of defocusing of the photographing lens unit 350 based on a phase difference between a pair of focus detection signals (A image and B image) obtained from the image sensor 303. In addition, the focus control unit 361 converts the amount of defocusing and the direction of defocusing to an amount of driving and a direction of drive of the focus motor 360. The focus control unit 361 controls an operation of the focus motor 360 based on the amount of drive and the direction of drive to drive the focus lens 359, and thereby a focus of the photographing lens unit 350 is controlled (focus adjustment).

As described above, the focus control unit 361 performs phase difference detection-type auto-focusing (AF). Further, the focus control unit 361 may perform contrast detection-type AF to search the peak of a contrast of an image signal obtained from the image sensor 303.

371 denotes a tracking unit for tracking a player of interest by the digital camera itself. Tracking mentioned here refers to, for example, moving display of a frame surrounding a player of interest within the screen and putting the focus on the player of interest being tracked with the frame or adjusting exposure.

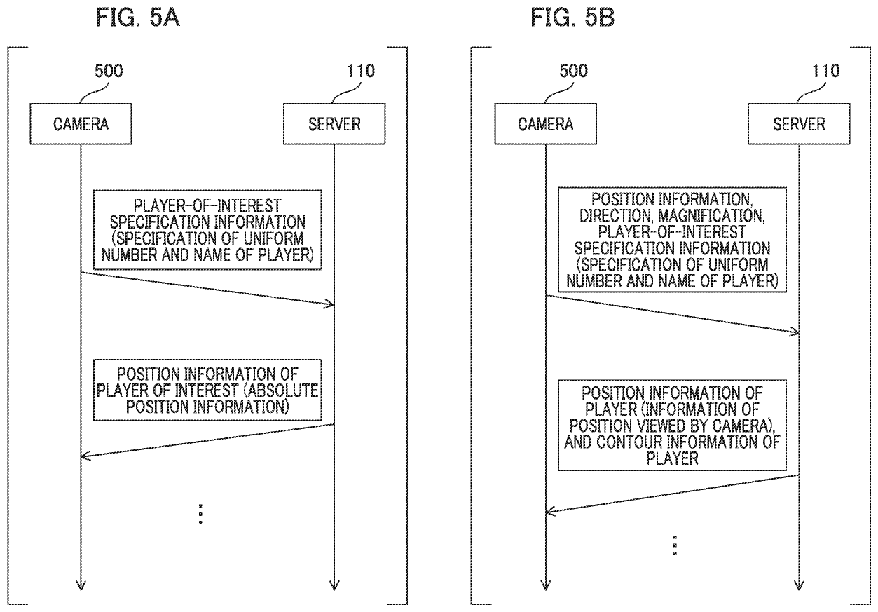

Next, an example of a player-of-interest display start sequence will be described using FIG. 5. This sequence is performed by the server 110 and the camera 500. FIG. 5A illustrates a sequence in which the server 110 side answers to a question (request) of the camera 500 side. In addition, the server 110 side provides the camera 500 side with information regarding an absolute position of the player of interest.

The camera 500 notifies the server 110 of player-of-interest specification information (ID information such as the uniform number or the name of the player). At this time, a user may touch the position of the player of interest on the screen of the terminal or may keep his or her fingers in contact with the screen and surround the player of interest with the fingers.

Alternatively, the user may touch the name of a player of interest on a list of multiple players in a menu displayed on the screen or may cause a character input screen to be displayed on the screen to input the name or uniform number of the player.

At that time, the user may touch the position of the face of the player of interest on the screen to recognize the image of the face or the uniform number and thereby the name, the uniform number, or the like of the player may be sent. Alternatively, the server side may recognize the images by sending the face image to the server, without image recognition. In addition, if there is a predetermined password in that case, the password may be sent to the server.

The server side sends information regarding the absolute position of the player based on player-of-interest specification information (ID information such as the uniform number or the name of the player) to the camera using a block that supports photographing of a video. If a password is sent from the camera, content of information to be sent to the camera is changed according to the password.

FIG. 5B illustrates another player-of-interest display start sequence. The camera notifies the server of position information of the camera currently being used by a professional cameraman or a general spectator for photographing, a direction of the camera, a magnification of the camera, and player-of-interest specification information (specified uniform number or name of the player).

The server side creates a free viewpoint video using the position information of the camera, the direction of the camera, and the magnification of the camera. In addition, the server side sends position information indicating the position of the player in the video actually seen by the camera and contour information of the player photographed by the camera to the camera based on player-of-interest specification information (specified uniform number or name of the player).

The camera displays the player of interest on the screen of the display unit of the camera more accurately and conspicuously based on the position information and the contour information sent from the server and performs AF and AE on the player of interest.

Further, when a building to be noted, or the like is specified, for example, the server may send contour information of the building to the camera, instead of notifying the camera of player-of-interest specification information (specified uniform number or name of the player).

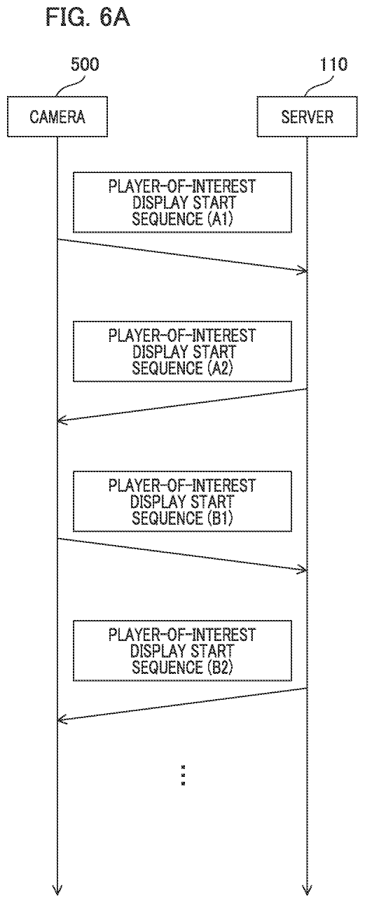

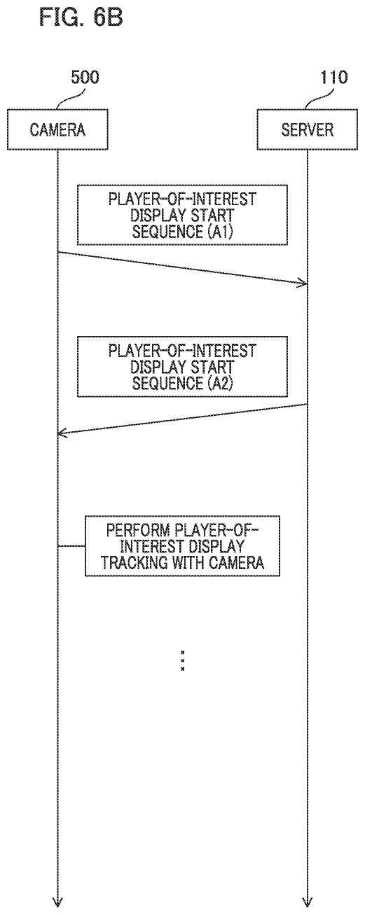

Although the example of the player-of-interest display start sequence to find the player of interest has been briefly described, the terminal side may desire to continuously track the player. Thus, a player-of-interest display tracking sequence will be described using (A) of FIG. 6. In FIG. 6A, the camera 500 serving as a terminal periodically makes inquiries (requests) to the server 110 many times to continuously check a position of a player.

In FIG. 6A, for obtaining position information of a player, ID information of the player of interest is sent from the camera 500 to the server 110 to temporarily place the player of interest in the field of view of the camera. Thereafter, by continuously repeating the above-described “start of camera display of the player of interest,” “tracking of camera display of the player of interest” can be realized. Specifically, the operation of recognizing the position of the player of interest is repeated many times by periodically sending the player-of-interest display start sequence (A1, B1, . . . ) from the camera to the server and periodically receiving the player-of-interest display start sequence (A2, B2, . . . ) from the server.

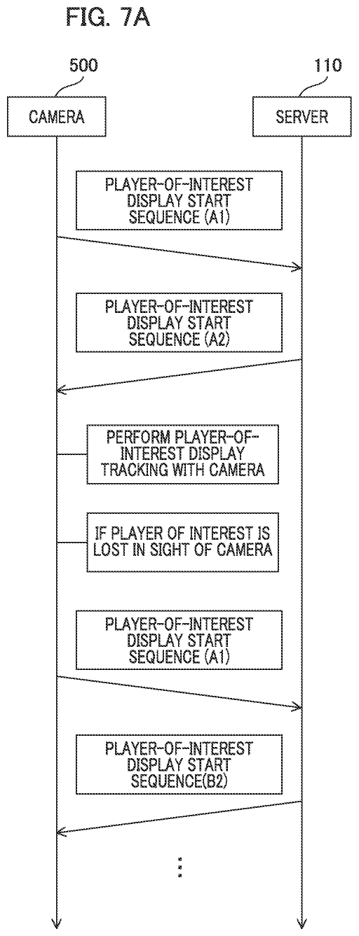

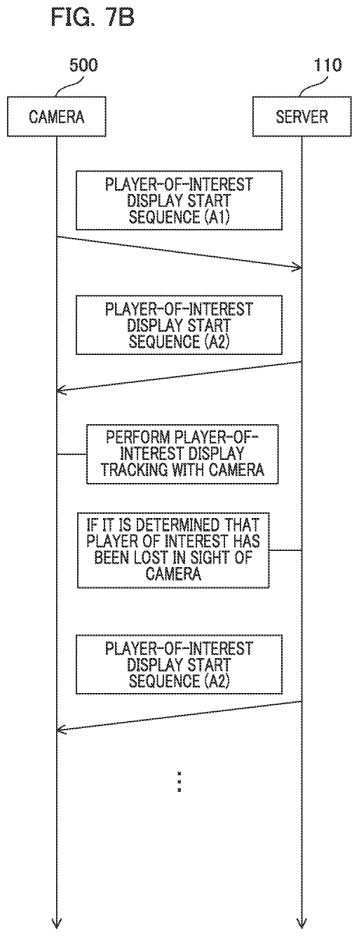

Furthermore, in FIG. 6B, for the position information of the player, ID information of the player of interest is sent from the camera 500 to the server 110 and position information of the player of interest is first acquired from the server. Then, after the player of interest is placed in the field of view of the camera with reference to the position information, the camera 500 continues to track the player of interest by itself through image recognition. In FIG. 7A, the camera 500 further tracks the player of interest by itself through image recognition in the player-of-interest display tracking sequence of FIG. 6B; however, when the player is lost to sight thereafter, the device side requests the position information of the player of interest from the sever.

Specifically, when the camera loses the player of interest from sight, the camera sends the player-of-interest display start sequence (A1) to the server and receives the player-of-interest display start sequence (A2) from the server, and thereby recognizes the position of the player of interest. FIG. 7B represents a case in which the server 110 further predicts that the camera 500 has a high likelihood of losing the player of interest to sight in the player-of-interest display tracking sequence of FIG. 6B.

In other words, the diagram represents push-type control in which position information of the player of interest is notified without waiting for a request from the camera 500 when it is predicted that tracking will fail. Thus, professional cameramen and general spectators can continuously detect the position of the player of interest on the display unit of the camera which is very easy to use and the number of missed photo opportunities can be greatly reduced, for example. Here, cases in which a professional cameraman or a general spectator loses sight of a player of interest include a case in which a player is in a maul, ruck, or scrum and thus is not able to be seen from outside (a case in which the player is in a blind spot), or a case in which the player is not seen from a direction of a certain camera.

Further, although the example of the service of assisting professional cameramen and spectators with photographing has been described, the example may be used in remote camera control. By sending the information from the server, a player can be tracked and photographed at a decisive moment using a remote camera mounted on an automatic pan/tilt head.

In addition, although the present example has been described using an example of photographing assistance, the terminal may be a home TV. In other words, a viewer who is watching a TV specifies a player of interest, a server sends position information of the player of interest, or the like to the TV and thereby the player of interest may be displayed conspicuously using frame display, or the like.

Further, the player of interest may be indicated by a cursor (e. g., an arrow, etc.) rather than a frame, or the color or luminance of the region of the position of the player of interest may be different from other portions. If the player of interest is outside of the screen of the terminal, the direction in which the terminal deviates from the screen may be displayed using an arrow or character.

In addition, if the player is outside of the displayed screen, how far the player is away (deviates) from the angle at which the terminal is currently viewing, how much the terminal needs to be rotated to have the player of interest on the displayed screen, or the like may be displayed using a length or thickness of an arrow, a number, a scale, or the like.

Furthermore, if the player of interest is within the screen, control may be performed such that additional information is displayed on the screen, and if the player of interest moves outside of the screen, the user may select not to display the player outside of the screen with an arrow, or the like.

Alternatively, by automatically determining a situation of a game, the player of interest being outside of the screen may not be displayed using an arrow, or the like even if the player moves out of the screen in a case in which the player of interest goes down to the bench, or the like. If the user is allowed to select a mode in which display of additional information is automatically turned off and a mode in which display is not turned off, usability can be further improved.

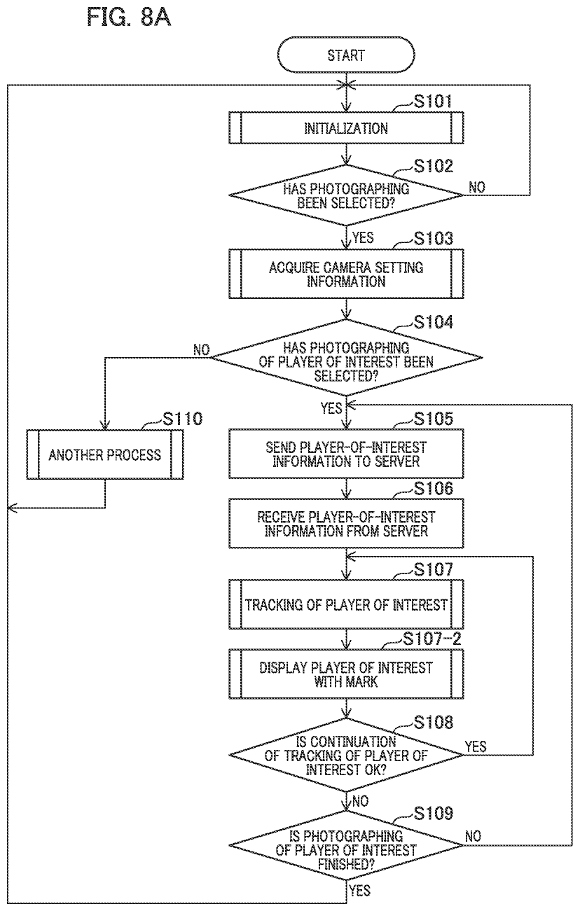

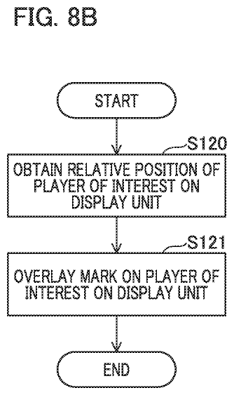

Next, details of the control sequence of the camera side of FIG. 7 will be described using FIG. 8A and FIG. 8B. FIG. 8A and FIG. 8B illustrate a player-of-interest display tracking control flow on the camera side.

In FIG. 8A, S101 represents initialization. In S102, it is determined whether photographing has been selected, and if photographing has been selected, the process proceeds to S103, and if photographing has not been selected, the process proceeds to S101. In S103, camera setting information is acquired. In S104, it is determined whether photographing (specification) of a player of interest has been selected, and if photographing of a player of interest has been selected, the process proceeds to S105, and if photographing of a player of interest has not been selected, the process proceeds to S110 to perform another process.

In S105, if there are information of the player of interest (ID information or the like of the player of interest) and a password, they are sent from the camera to the server. Accordingly, the server side detects the position information of the player of interest and transmits the information to the camera. In S106, the position information of the player of interest, or the like is received from the server.

In S107, the camera tracks the player of interest by itself while referring to the position information sent from the server. Here, the camera tracks the player of interest by itself performing, for example, image recognition. In this case, the player is tracked based on a recognition result of any of the uniform number of the player, face information of the player, the physique of the player, and the like or a combination thereof. In other words, the player of interest is tracked by recognizing an image of a part or the entire shape of the player. However, there is a possibility of the player being lost to sight when a photographing position of the user is poor when the field of view of the camera is narrow, or when the player is hidden behind another subject due to a photographing angle or the like, and if the player is lost to sight, a request for the position information is sent to the server again.

S107-2 shows an example of mark display as additional information with respect to the player of interest. In other words, as additional information, a cursor indicating the player of interest is displayed, a frame is displayed at the position of the player of interest, the color or luminance of the position of the player of interest is changed to be conspicuous or display in combination of these is performed. Display may be performed with characters in addition to a mark. In addition, additional information indicating a position may be overlaid on the player of interest while the image display unit displays a live view image from the image sensor.

The flow of S107-2 for displaying a mark is exemplified in FIG. 8B, and this will be described below. Further, the user may be able to select skipping the tracking operation of S107 described above and not to perform tracking. Alternatively, a mode in which the tracking operation is performed when the player of interest is present on the screen, but the tracking operation is not performed when the player is outside of the screen may be provided to be selected. Furthermore, when a situation of a game is automatically determined, for example, when the player of interest enters the bench, or the like, the tracking operation for the player of interest being outside of the screen (displaying additional information such as an arrow etc.) may be automatically stopped.

Alternatively, regardless of being in the screen or outside of the screen, if the server knows that the player of interest has entered the bench, display of the position of the player of interest on the screen, auto-focusing on the player of interest, automatic exposure adjustment with respect to the player of interest may be stopped.

Whether the continuation of tracking of the player of interest is OK (successful) is determined in S108, and if the continuation of tracking of the player of interest is successful, the process proceeds to S107, and tracking of the player of interest is continuously performed by the camera itself, and if the continuation of tracking of the player of interest is not successful, the process proceeds to S109.

Whether the photographing of the player of interest is finished is determined in S109, and if the photographing of the player of interest is finished, the process proceeds to S101. If the photographing of the player of interest continues, the process proceeds to S105, information of the player of interest is sent to the server again, information of the player of interest is received from the server in 106, the position of the player of interest is recognized again, and the photographing of the player of interest continues. In other words, if the tracking fails, the result of S108 is NO, and the tracking continues in that case, the process returns to S105 to make a request for position information to the server.

FIG. 8B shows the flow of player-of-interest mark display control on the camera side. In S120, a relative position of the player of interest on the display unit is obtained through calculation. In S121, additional information indicating a position, or the like is overlaid on the player of interest while the image display unit displays a live view image from the image sensor.

In the above example, the server 110 reads a video of the entire field of the game and acquires coordinates, and thus also can ascertain from where the professional cameramen and spectator have photographed the field of the game from the video photographed by them.

In other words, the server ascertains a video of the entire field of the game in advance from multiple cameras (fixed cameras and mobile cameras) for the server. Accordingly, information of the absolute position of the player of interest in the field can be mapped to the video viewed by a professional cameraman and spectator through the terminal and digital camera.

In addition, when the terminal such as the camera of a professional cameraman and spectator receives the information of the absolute position of the player from the server, the information of the absolute position can be mapped to the video being captured or monitored now.

Further, the information of the absolute position of the player of interest within the field from the server is assumed as (X, Y). This information of the absolute position needs to be converted to relative position information (X′. Y′) viewed from the camera according to the position information of the individual camera. The conversion of the information of the absolute position to the relative position information may be performed by the camera side as in S120 or may be converted by the server side and then the relative position information may be sent to individual terminals (cameras, etc.).

If the conversion is performed by a terminal such as a camera, the information of the absolute position (X, Y) sent from the server is converted to the relative position information (X′, Y′) according to position information of the individual cameras obtained using the GPS, or the like. Position information within the display screen of the camera side is set based on the relative position information.

On the other hand, if the conversion is performed by the server, the server converts the information of the absolute position (X, Y) to the relative position information (X′, Y′) of the individual cameras according to the position information of the individual cameras obtained using the GPS, or the like. The server sends this relative position information to the individual cameras, and the cameras that have received the relative position information sets the relative position information as position information of the individual camera side within the display screen.

As described above, losing the player of interest to sight of the terminals such as cameras of the professional cameramen and spectators is reduced, and thus good photos of the player of interest can be photographed without missing the timing.

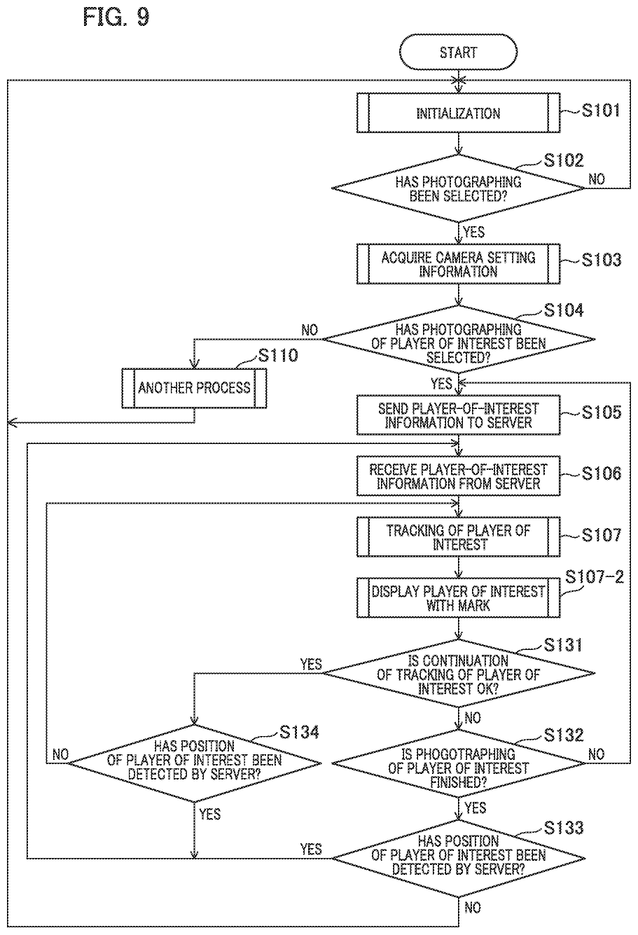

Further, another example of the control sequence on the camera side based on FIG. 7 is shown in FIG. 9. FIG. 9 shows another example of the player-of-interest display tracking control flow of the terminal side such as a camera. In FIG. 9, S101, S102, S103, S104, S105, S106, S107, S107-2, and S110 are for control the same as in FIG. 8, and thus description thereof will be omitted.

Whether the continuation of tracking of the player of interest is OK (successful) is determined in S131, and if the continuation of tracking of the player of interest is successful, the process proceeds to S134, and if the continuation of tracking of the player of interest is not successful, the process proceeds to S132. Whether the photographing of the player of interest is finished is determined in S132, and if the photographing of the player of interest is finished, the process proceeds to S133.

If the photographing of the player of interest continues, the process proceeds to S105, information of the player of interest is sent to the server again, information of the player of interest is received from the server in 106, the position of the player of interest is recognized again, and the photographing of the player of interest continues. Whether the server has detected the position of the player of interest is determined in S133, and if the server has detected the position of the player of interest, the process proceeds to S106, and if the server has not detected the position of the player of interest, the process proceeds to S101.

Whether the server has detected the position of the player of interest is determined in S134, and if the server has detected the position of the player of interest, the process proceeds to S106, and if the server has not detected the position of the player of interest, the process proceeds to S107.

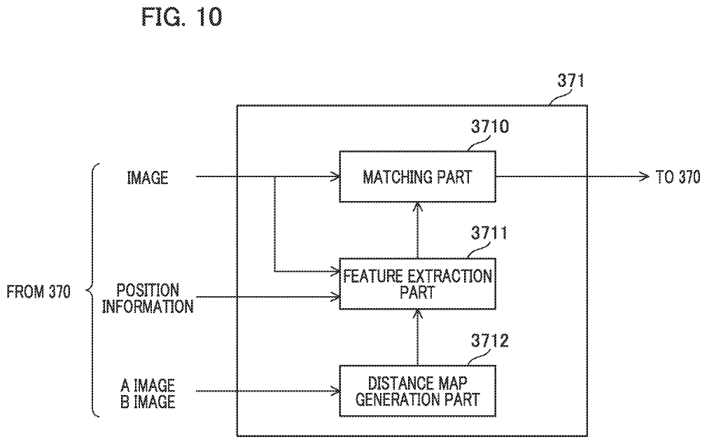

Next, the tracking unit 371 of the digital camera will be described using FIG. 10.

FIG. 10 is a block diagram illustrating a functional configuration example of the tracking unit 371 of the digital camera. The tracking unit 371 includes a matching part 3710, a feature extraction part 3711, and a distance map generation part 3712. The feature extraction part 3711 specifies an image region (subject region) to be tracked based on position information sent from the server.

In addition, a feature value is extracted from an image of the subject region. Meanwhile, the matching part 3710 refers to the extracted feature value to search for a region having a high similarity to a subject region of the previous frame as a subject region within captured images of individual frames that are continuously supplied. Further, the distance map generation part 3712 can acquire information of the distance to the subject from a pair of parallax images (A image and B image) from the image sensor and thus accuracy in specification of the subject region by the matching part 3710 can be improved. However, the distance map generation part 3712 may not necessarily provided.

When the matching part 3710 searches for a region having a high similarity to the subject region as a subject region based on the feature value of the subject region in the image supplied from the feature extraction part 3711, for example, template matching, histogram matching, or the like is used.

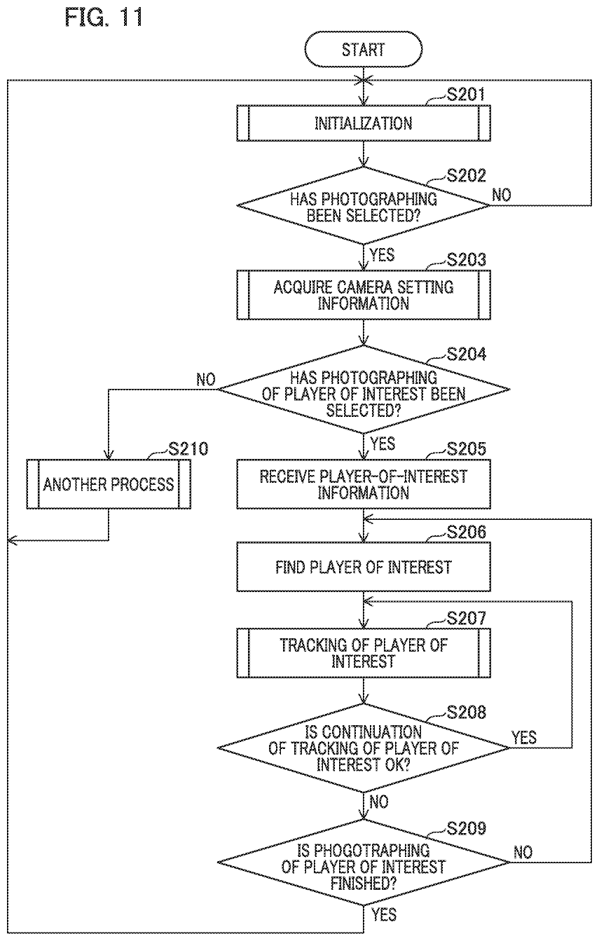

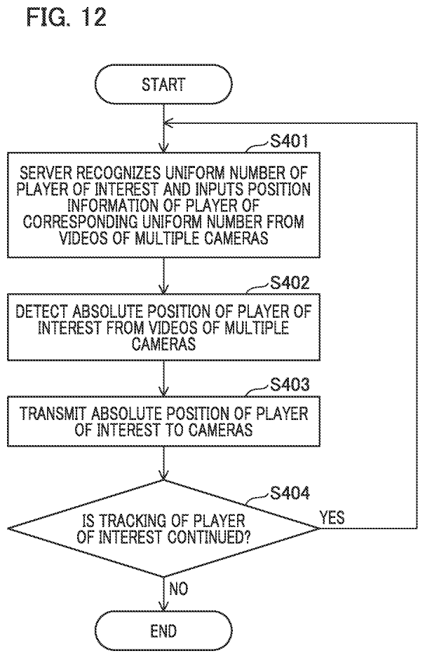

Next, the flow of the player-of-interest detection control on the server side will be described using FIGS. 11 and 12.

The server performs image recognition on the player of interest based on the ID information of the player of interest, or the like sent from the terminal such as the camera. The server detects the position information of the player based on the videos from the multiple cameras (fixed cameras, mobile cameras, and the like) for the server and sends the position information of the player to the camera terminals and the like of professional cameramen and spectators.

In particular, if there is the position information of the player of interest provided from the server when professional cameramen and spectators perform photographing, the player of interest can be surely photographed without making a mistake. Furthermore, the information from the server is also important when the cameras perform tracking of the player of interest and lose sight of the player due to a blind spot, or the like. Further, the server side keeps detecting the position information of the player based on videos from the multiple cameras for the server.

The terminals such as cameras possessed by professional cameramen and general spectators send the ID information of the player of interest to the server and track the player of interest based on the position information acquired from the server. At the same time, the terminals such as cameras possessed by the professional cameramen and general spectators can detect the position of the player of interest by themselves.

FIG. 11 shows the main flow of player-of-interest detection control on the server side.

In FIG. 11, initialization is performed first in S201. Next, whether photographing has been selected in the camera is determined in S202, and if photographing has been selected, the process proceeds to S203 to acquire camera setting information. At this time, a password is acquired if the camera setting information includes the password. If photographing has not been selected, the process proceeds to S201.

Whether photographing (specification) of the player of interest has been selected is determined in S204, and if photographing of the player of interest has been selected, the process proceeds to S205, and the server receives the ID information (e.g., the name or the uniform number of the player, etc.) of the player of interest from the camera. If photographing of the player of interest has not been selected in S204, the process proceeds to S210 to perform another process.

In S206, the server finds the player of interest within the screen based on the ID information of the player of interest through image recognition based on the videos from the multiple cameras (fixed cameras, mobile cameras, etc.). In S207, the server tracks the player of interest based on the videos from the multiple cameras. Whether the continuation of tracking of the player of interest is OK (successful) is determined in S208, and if the continuation of tracking of the player of interest is successful, the process returns to S207 to continue tracking of the player of interest based on the information from the multiple cameras. If the continuation of tracking of the player of interest is not successful in S208, the process proceeds to S209.

Whether photographing of the player of interest is finished is determined in S209, if photographing of the player of interest is finished, the process returns to S201, and if photographing of the player of interest continues in S209, the process returns to S206. Then, the server searches for information from the camera for the multiple servers (fixed cameras and mobile cameras) based on the ID information of the player of interest to find the player of interest, and continuously tracks the player of interest based on the videos from the multiple cameras in S207.

Next, an example of a method for finding the player of interest in S206 and tracking the player in S207 described above will be described using FIG. 12.

FIG. 12 shows the flow of player-of-interest detection control of the server using uniform number information. In FIG. 12, the server acquires the uniform number from the data memory 213 based on the ID information of the player of interest, searches for the uniform number from video information of the multiple cameras for the server through image recognition and acquires position information of the player with the uniform number in S401. In S402, information of the absolute position of the player of interest is further acquired by combining position information acquired from videos of the multiple cameras for the server.

By combining the information of the multiple cameras for the server as described above, accuracy in the information of the absolute position of the player with a certain uniform number is improved. In S403, the absolute position of the player of interest detected in S402 is transmitted to the terminals such as the cameras possessed by the professional cameramen and spectators. Whether tracking of the player of interest is continued is determined in S404, and if tracking of the player of interest is continued, the process returns to S401, and if tracking of the player of interest is not continued, the flow of FIG. 12 ends.

Further, the uniform number of the player of interest is found using the video from at least one camera among the multiple cameras for the server, information of a shown size, angle, and further background (the field of the game) is input, and thus the position information of the player of interest can be acquired. In addition, the uniform number of the player of interest is set to be found likewise using the videos from the multiple cameras for the server, information of a shown size, angle, and further background (the field) is input, and thus accuracy in the position information of the player of interest can be improved.

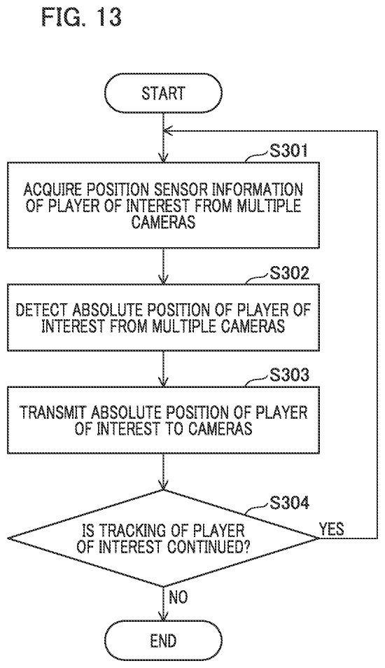

Next, an example of another detection method for detecting a position of the player of interest will be described using FIG. 13.

In this example, it is assumed that the player himself or herself allows a position sensor to be installed in the cloth such as the uniform or the player wears a position sensor using a belt or the like around his or her arm, waist, leg, or the like. In addition, the server (the multiple cameras or the like on the side) recognizes a signal from the position sensor of the player when the position sensor wirelessly sends information to the server side using a communication unit to generate position information, and the server notifies the cameras possessed by professional cameramen and general spectators of the position information.

The detailed flow of player-of-interest detection control by the server side using information of the position sensor is shown in FIG. 13. In FIG. 13, S301 is for the server to receive and acquire information of the position sensor of the player of interest from the multiple cameras. Each of the multiple cameras includes a detection unit that receives radio waves from the position sensor, detects the direction of the radio waves being received and the level of the radio waves being received, and acquires the factors as information of the position sensor. The information of the position sensor also includes the direction of radio waves being received and the level of the radio waves being received.

The absolute position of the player of interest is detected based on the information of the position sensor from the multiple cameras in S302. The absolute position of the player of interest is transmitted to the cameras in S303. Whether tracking of the player of interest is continued is determined in S304, and if tracking of the player of interest is continued, the process proceeds to S301, and if tracking of the player of interest is not continued, the control ends.

In the case of this example, at least one of the multiple cameras (fixed cameras and mobile cameras) has a detection unit that detects information from the position sensor possessed by the player, in addition to acquisition of images and sound.

At least one of the multiple cameras can receive the information from the position sensor of the player and recognize the direction of radio waves being received and further the level of the radio waves being received.

Although the position of the player can be detected based on the detection result of only one camera described above, the information of the position sensor of the player is set to be recognized by each of the multiple cameras in this example. In addition, the position information of the player can be analyzed more accurately by combining information of the direction of the radio waves and the level of the radio waves on which the multiple cameras are receiving the sensor information of the player of interest.

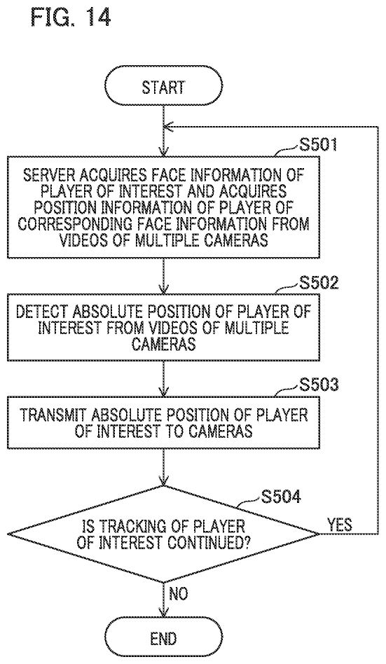

Next, the flow of player-of-interest detection control on the server side using face recognition information is shown in FIG. 14.

The data memory 213 of the server stores multiple pieces of information of faces of players who are registered as members for matches, the faces having been photographed in the past. Furthermore, the server has a unit that detects face information of players based on videos from the camera for the multiple servers. Then, the server compares the information of the face of a player who is registered as a member for a match and had been photographed in the past with multiple photos based on face information detected by the camera for multiple servers to recognize the face using, for example, AI, and detect the player of interest.

In FIG. 14, S501 is for the server to acquire multiple pieces of face information of the player of interest from the data memory 213 based on the ID information of the player of interest and acquire position information of the player of the face information using videos from the multiple cameras for the server. If the player corresponding to the face information of the player of interest is found using the video from one camera among the multiple cameras for the server, information of a shown size, angle, and further background (the field) is input, and thus the position information of the player of interest can be acquired. The player corresponding to the face information of the player of interest is found likewise using the multiple cameras for the server, information of a shown size, angle, and further background (the field) is input, and thus the position information of the player of interest can be acquired with higher accuracy.

In S502, the absolute position of the player of interest is detected based on the position information of the player of interest acquired from the videos of the multiple cameras in S501. In S503, information of the absolute position of the player of interest detected in S502 is transmitted to the cameras possessed by the professional cameramen and general spectators. Whether tracking of the player of interest is continued is determined in S504, and if tracking of the player of interest is continued, the process proceeds to S501, and if tracking of the player of interest is not continued, the control ends.

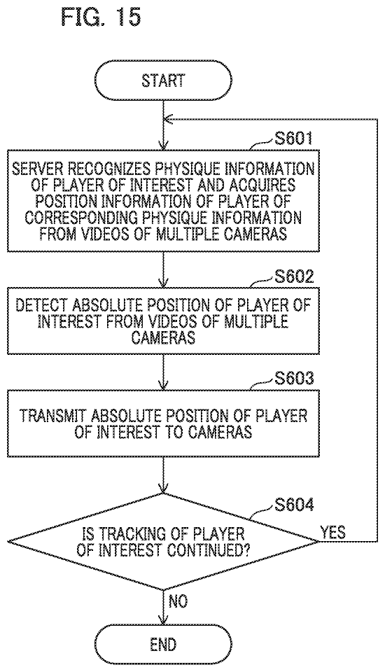

Next, a method for detecting a position of the player using his or her physique (body shape) will be described using FIG. 15.

The data memory 213 of the server stores multiple pieces of physique image information of players who are registered as members for matches, the physiques having been photographed in the past. Furthermore, the server has a unit that detects physique information of players based on videos from the multiple cameras for the server. Then, the server compares the physique information detected from the multiple cameras for the server with multiple pieces of the physique image information of players who are registered as members for a match and had been photographed in the past using, for example, AI, and detects the player.

The detailed flow of player-of-interest detection control by the server using physique (body shape) recognition information is shown in FIG. 15. In S601 of FIG. 15, the server acquires multiple pieces of physique image information from the data memory 213 based on the ID information of the player of interest and acquires position information of the player with the physique using video information from the multiple cameras for the server. If the player corresponding to the physique information of the player of interest is found using the video from one camera among the multiple cameras for the server, information of a shown size, angle, and further background (the field) is acquired, and thus the position information of the player of interest can be acquired.

The player corresponding to the physique image of the player of interest is found likewise using the videos from the multiple cameras for the server information of a shown size, angle, and further background (the field) is acquired, and thus the position information of the player of interest can be acquired. By combining the information of the multiple cameras, accuracy in the position information of the player of interest based on the physique information can be improved.

In S602, the absolute position of the player of interest is detected based on the position information of the player with the physique information acquired in S601.

In S603, the absolute position of the player of interest detected in S602 is transmitted to the camera terminals possessed by the professional cameramen and general spectators. Whether tracking of the player of interest is continued is determined in S604, and if tracking of the player of interest is continued, the process proceeds to S601, and if tracking of the player of interest is not continued, the control of FIG. 15 ends.

Although the position sensor information, uniform number recognition, face recognition, physique recognition, and the like with respect to the player have been described, information of a uniform (design and color), shoes, a hair style of the player, a motion of the player, and the like may be subject to image recognition and thus accuracy in recognition of a player of interest can be improved.

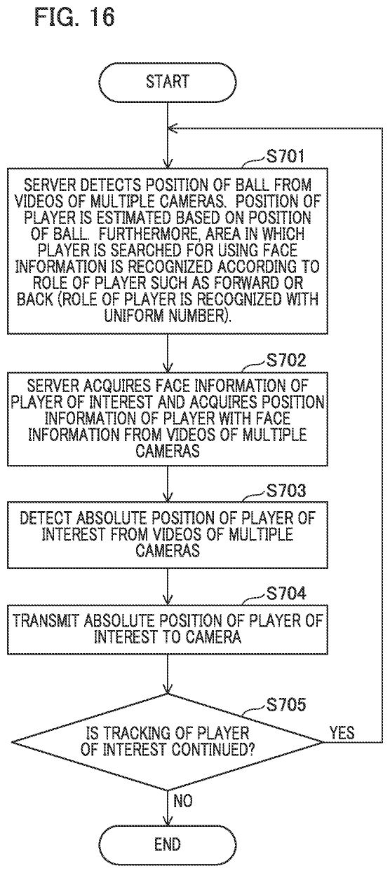

Next, FIG. 16 is of an auxiliary detection method for the player-of-interest detection method, showing the flow for detecting a player of interest based on a basic role (so-called position) in the field of a game.

The data memory 213 of the server stores information of roles (positions) of players in the field of a game. Furthermore, because positions based on the role of the players change according to a position of the ball, the information of the position is also stored.

The server detects the current position of the ball from videos of the multiple cameras and recognizes the status of the match (whether the player is offending or defending). A rough position of a player is easily detected using this information. In other words, a location of a player according to his or her role is estimated by determining a situation of a game and focusing on the role of the player. This determination is mainly made on the server side.

An example of the flow of player-of-interest detection control considering a role of a player is shown in FIG. 16. In S701 of FIG. 16, the server detects position information of the ball based on videos from multiple cameras. A position of the player is roughly estimated using the position information of the ball. Furthermore, an area in which a player is searched for using face information is recognized according to the role of the player such as forward or back (the role of the player is recognized with the uniform number). In S702, the server acquires multiple pieces of face information of the player of interest from the data memory 213, compares the information with video information of the multiple cameras, and acquires position information of the player with the face information.

In S703, absolute position of the player of interest is detected based on the position information of the player of interest acquired from the videos of the multiple cameras in S702. In S704, the absolute position of the player of interest detected in S703 is transmitted to the cameras possessed by the professional cameramen and general spectators. Whether tracking of the player of interest is continued is determined in S705, and if tracking of the player of interest is continued, the process proceeds to S701, and if tracking of the player of interest is not continued, the flow of FIG. 16 ends.

Here, although a situation of a match (whether a certain team is offending or defending) is determined based on a position of the ball, for example, control based on a situation of the match is not limited to a position of the ball. For example, when a certain team commits a foul, a penalty kick, or the like is given to the opposing team. In this case, the team that has gained the penalty kick is highly likely to advance from the current position of the ball in the match. Thus, control may be performed based on a situation of the match in which the team is predicted to advance. Such prediction may be made assuming that the position of the ball is a foul.

As described above, according to the present embodiment, professional cameramen and general spectators can be notified of position information of the player of interest in a timely manner when they perform photographing with cameras, spectators watch the match using their terminals, and the like. Thus, the professional cameramen and general spectators can sequentially recognize the positions of the player of interest and photograph good play of the player of interest satisfactorily.

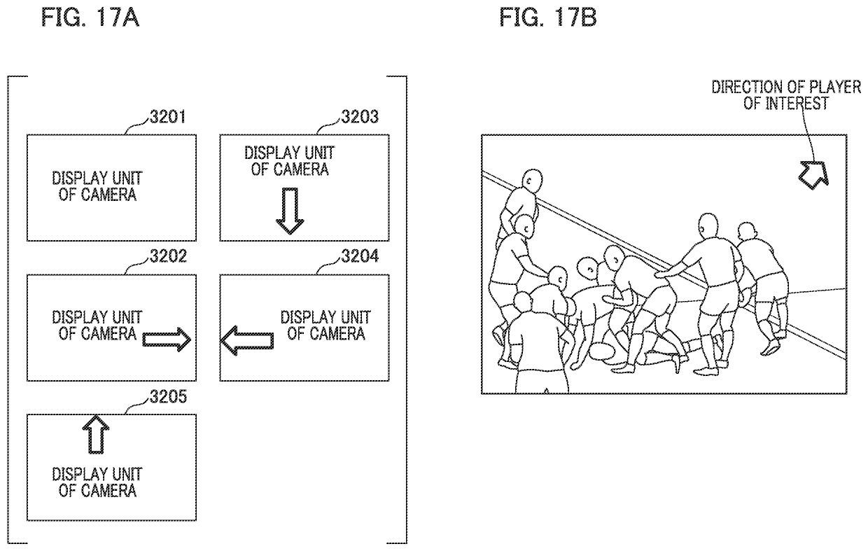

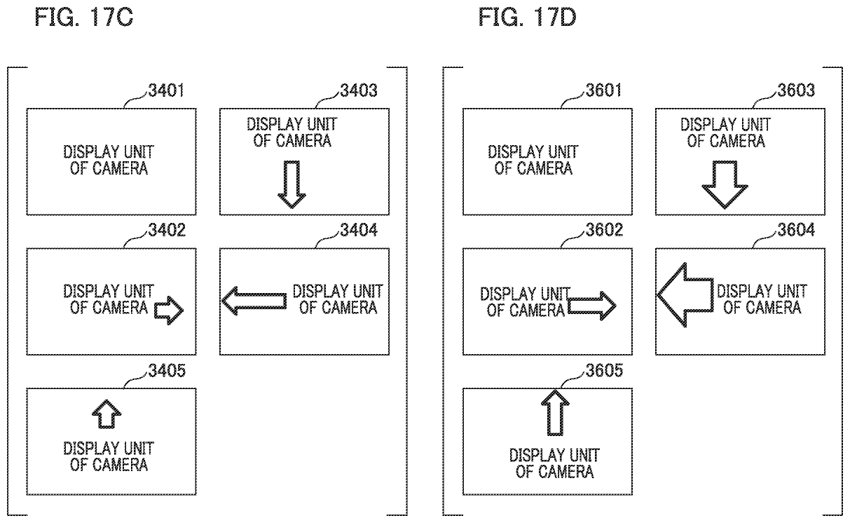

Next, an example of a display method when position information of a player of interest is displayed on a camera possessed by a professional cameraman or general spectator will be described using FIG. 17A to FIG. 17D.

In the present embodiment, when position information of the player of interest is sent from the server while the image display unit of a terminal such as a camera displays a live view image from the image sensor, a mark, a cursor, an arrow, a frame, or the like serving as additional information is displayed to be overlaid on the position of the player of interest. Here, if the player of interest is outside of the screen of the image display unit, the direction in which the player of interest is present is displayed at a peripheral part on the screen of the display unit. Watching this display, it is possible to quickly recognize the direction in which the camera needs to face to place the player of interest in the screen in the photographing area if the professional cameraman or general spectator sees the screen of the terminal such as the camera that he or she possesses.

FIG. 17A illustrates an example of display of position information of the player of interest in videos of the display unit of a camera. 3201 denotes the display unit of the camera. Here, if the player of interest is outside of the display screen of the display unit and on a right side of the display screen, a rightward arrow is displayed near the right side of the screen of the display unit as indicated by 3202. In addition, if the player of interest is outside of the display area and on a lower side of the display screen, a downward arrow is displayed near the lower side of the screen of the display unit as indicated by 3203.

In addition, if the player of interest is outside of the display area and on a left side of the display screen, a leftward arrow is displayed near the left side of the screen of the display unit as indicated by 3204. In addition, if the player of interest is outside of the display area and on an upper side of the display screen, an upward arrow is displayed near the upper side of the screen of the display unit as indicated by 3205. Further, if the player of interest is in an oblique upper-right direction, for example, an oblique upper-rightward arrow is displayed near a place in the oblique upper-right direction on the screen as illustrated in FIG. 17B. Thus, it is possible to know that the player of interest is in the oblique upper-right direction as illustrated in FIG. 17B.

These arrows help professional cameramen and general spectators know the direction in which the camera needs to move to place the player of interest in the photographing area of the camera when they photograph the player of interest. Accordingly, the professional cameramen and general spectators can place the player of interest on the photographing screen soon even they once lose sight of the player and can photograph the player of interest without missing the opportune shutter moment.

Next, FIG. 17C is a diagram illustrating an example in which directions and lengths of arrows are displayed to indicate a direction and a degree in which the camera needs to move to place the player of interest in the photographing area. 3401 denotes the display unit of the camera.

Here, if the player of interest is outside of the display area and on the right side of the display screen, a rightward arrow is displayed near the right side of the screen of the display unit as indicated by 3402.

If the player of interest is outside of the display area and on a lower side of the display screen, a downward arrow is displayed near the lower side of the screen of the display unit as indicated by 3403. If the player of interest is outside of the display area and on a left side of the display screen, a leftward arrow is displayed near the left side of the screen of the display unit as indicated by 3404.

If the player of interest is outside of the display area and on an upper side of the display screen, an upward arrow is displayed near the upper side of the screen of the display unit as indicated by 3405. Moreover, in the above description, the degree at which the player of interest is outside of (deviates from) the screen, in other words, the degree at which the camera needs to be rotated to capture the player of interest, is indicated by a length of the arrow. A length of the arrow becomes longer as a position of the player of interest deviates from the field of view of the screen farther.

In FIG. 17C, because the length of the rightward arrow shown in 3402 is relatively short, it is seen that the player of interest can be placed in the photographing area by moving the camera in the right direction only by a relatively small angle.

Likewise, because the length of the upward arrow shown in 3405 is relatively short, it is seen that the player of interest can be placed in the photographing area only at a relatively small angle at which the camera is rotated upward. Meanwhile, because the downward arrow indicated by 3403 has a medium length, it is seen that the player of interest can be placed in the photographing area by rotating the camera at an angle larger than that of 3402 and 3405.

Furthermore, because the leftward arrow indicated by 3404 is relatively long, it is seen that the player of interest can be placed in the photographing area by rotating the camera in the direction of the player of interest by an angle larger than the rotation angle in 3403.

Accordingly, the professional cameramen and general spectators can place the player of interest in the photographing area (within the display screen) with ease and can photograph the player of interest without missing the opportune shutter moment.

Next, FIG. 17D is a diagram illustrating an example in which a thickness of an arrow is changed while keeping a length of the arrow constant. In other words, a thickness of the arrow may be increased if a rotation angle in the photographing area is large, in other words, if a rotation angle of the camera for placing the player of interest in the photographing area is large. 3601 denotes the display unit of the camera.

Here, if the player of interest is outside of the display area and on a right side of the display screen, a rightward arrow is displayed a peripheral part on the right side of the screen of the display unit as indicated by 3602. In addition, if the player of interest is outside of the display area and on a lower side of the display screen, a downward arrow is displayed at a peripheral part on the lower side of the screen of the display unit as indicated by 3603. In addition, if the player of interest is outside of the display area and on a left side of the display screen, a leftward arrow is displayed at a peripheral part on the left side of the screen of the display unit as indicated by 3604.

In addition, if the player of interest is outside of the display area and on an upper side of the display screen, an upward arrow is displayed at a peripheral part on the upper side of the screen of the display unit as indicated by 3605. Furthermore, in the above description, the rotation angle of the camera is indicated with a thickness of the arrow. A thickness of the arrow increases as a rotation angle increases.

In FIG. 17D, the arrow indicated by 3603 and the leftward arrow indicated by 3604 are thicker than the arrows indicated by 3602 and 3605, and thus it is seen that the player of interest is placed in the photographing area only if the camera is rotated by a relatively large angle.

With such display, professional cameramen and general spectators can find the player of interest who was lost to sight soon and can photograph good play of the player of interest without missing the opportune shutter moment.

Further, although a direction in which the player of interest deviates from the screen and an amount of deviation are displayed using arrows, and lengths and thicknesses thereof in the above-described example, the example is not limited thereto. For example, only a message indicating that the player of interest is not within the screen such as “the player of interest is outside of the screen on the oblique upper right side” may be displayed using text, instead of an arrow. In this case, a warning using sound, blinking, or the like may be displayed. Alternatively, “the position deviates to the right direction,” “the position deviates 20 degrees to the right in the horizontal direction,” or the like may be displayed, a needle rotating in the direction of the player of interest, like a compass, may be displayed at an edge of the screen, or a degree of deviation from the screen may be displayed at a corner of the screen using a number or a scale.

In other words, an amount of deviation may be displayed by displaying a scale and using a cursor placed at a position of the scale, or a length of a bar may be displayed to be changed along the scale according to an amount of deviation.

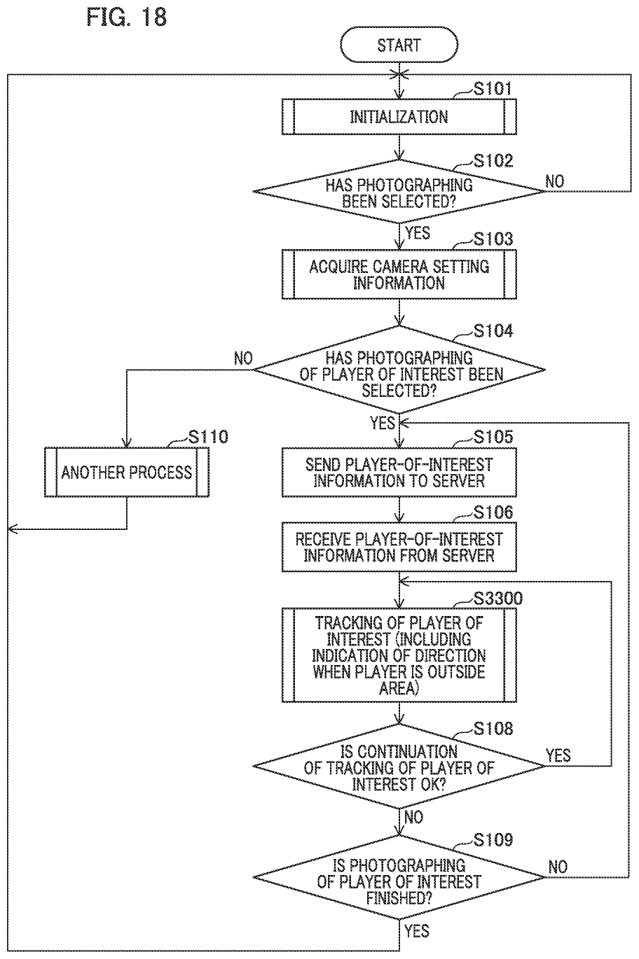

Next, FIG. 18 is a diagram illustrating another example of the player-of-interest display tracking control flow of the camera side.

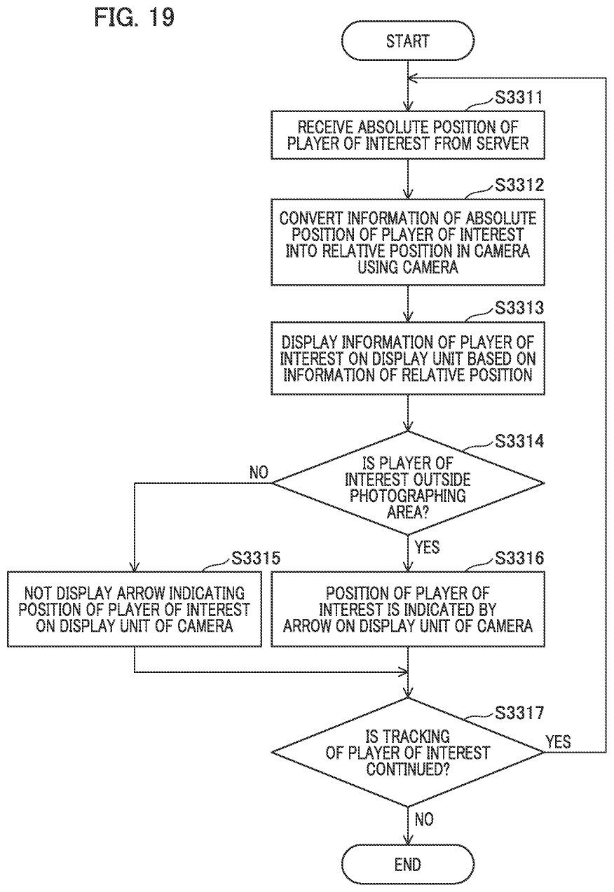

In FIG. 18, steps with reference numerals the same as those in FIG. 8, that is, steps except S3300 are the same as those in FIG. 8, and thus description thereof will be omitted. S3300 is to perform tracking of the player of interest by the camera itself. Here, when the player of interest is outside of the area being photographed by the camera, an arrow indicating the direction of the player is displayed on the display unit. A detailed flow of S3300 is shown in FIG. 19.

In S3311 of FIG. 19, the camera receives absolute position information of the player of interest from the server. In S3312, the camera converts the absolute position information of the player of interest to relative position information based on the position, the direction, the magnification, and the like for photographing of the camera. In S3313, the position of the player of interest is displayed on the display unit based on the information of the relative position viewed from the camera. In S3314, it is determined whether the player of interest is outside of the photographing area of the camera at the current time, that is, outside of the screen of the display unit of the camera, is determined, and if the player is outside of the screen, the process proceeds to S3316, and if the player is within the screen, the process proceeds to S3315.

In S3315, an arrow indicating the position of the player of interest is not displayed on the display unit of the camera. Instead, a mark such as a frame indicating the position of the player of interest is displayed. In S3316, the position of the player of interest is displayed at a peripheral part of the display unit of the camera using an arrow. Whether tracking of the player of interest is continued is determined in S3317, and if tracking of the player of interest is continued, the process proceeds to S3311, and if tracking of the player of interest ends, the flow of S3300 ends.

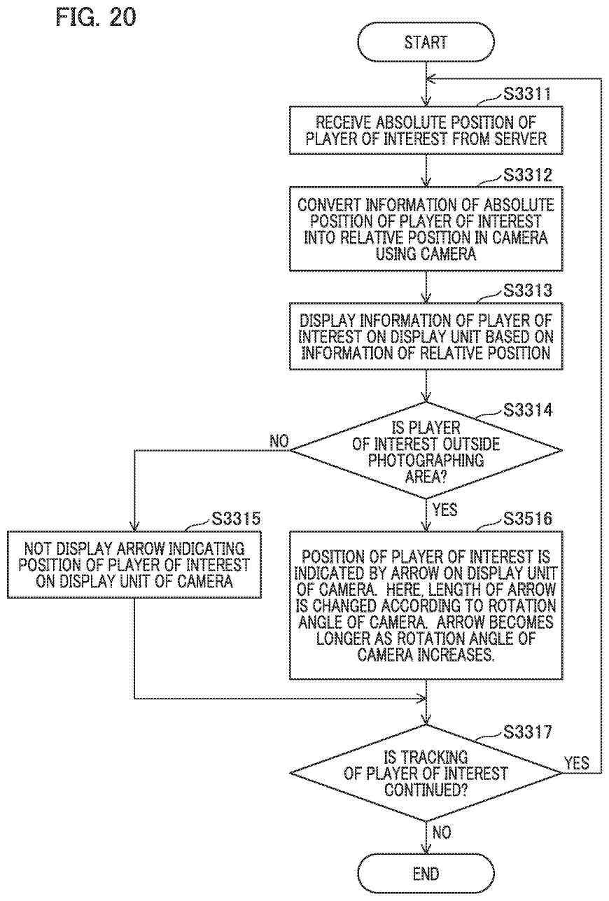

FIG. 20 is a diagram illustrating a flow for display of FIG. 17C in S3300 of FIG. 18. In FIG. 20, steps from S3311 to S3315 and S3317 are the same as those in FIG. 19, and thus description thereof will be omitted. In S3516, the position of the player of interest is displayed at a peripheral part within the screen of the display unit of the camera using an arrow. Here, a length of the arrow is changed according to a rotation angle of the camera at which the player is placed within the display screen. The arrow becomes longer as the rotation angle of the camera increases.

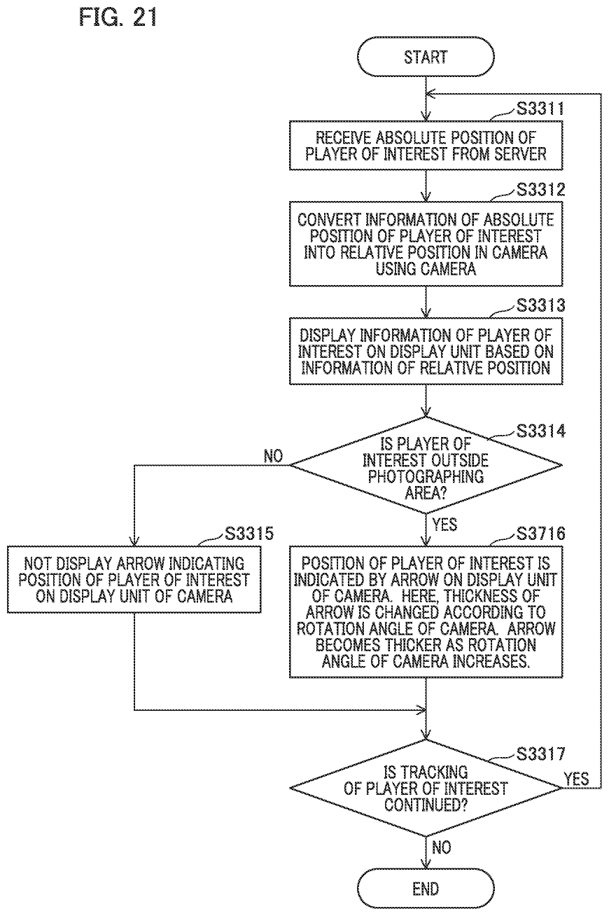

FIG. 21 is a diagram illustrating a flow for display of FIG. 17D in S3300 of FIG. 18. In FIG. 21, steps from S3311 to S3315 and S3317 are the same as those in FIGS. 19 and 20, and thus description thereof will be omitted. In S3716, the position of the player of interest is displayed at a peripheral part within the screen of the display unit of the camera using an arrow, and a thickness of the arrow is changed according to a rotation angle of the camera at which the player is placed within the display screen. The arrow becomes thicker as the rotation angle of the camera increases.

Further, although the number of players of interest is one in the example, the number of players of interest may be multiple. In addition, a player of interest is assumed to be switched in the middle of a game. Players of interest may be all players participating in a match. In addition, videos and images are assumed to include not only moving images but also still images. In addition, tracking of the player of interest has been mainly described. However, without tracking only the player of interest, information of a player having the ball or receiving the ball may be transmitted to professional cameramen and spectators and displayed. In addition, although the example in which a player is tracked is used to describe the example, it is needless to say that the embodiment can be applied to a system for tracking a person such as a criminal using multiple surveillance cameras.

Alternatively, the embodiment can be applied to a system for tracking a specific car, or the like in car racing, a system for tracking a horse in horse racing, and the like, without being limited to tracking a person. Further, although the example in which the player of interest is specified with a camera terminal, or the like has been described in the example, the server side may be able to specify the player of interest.

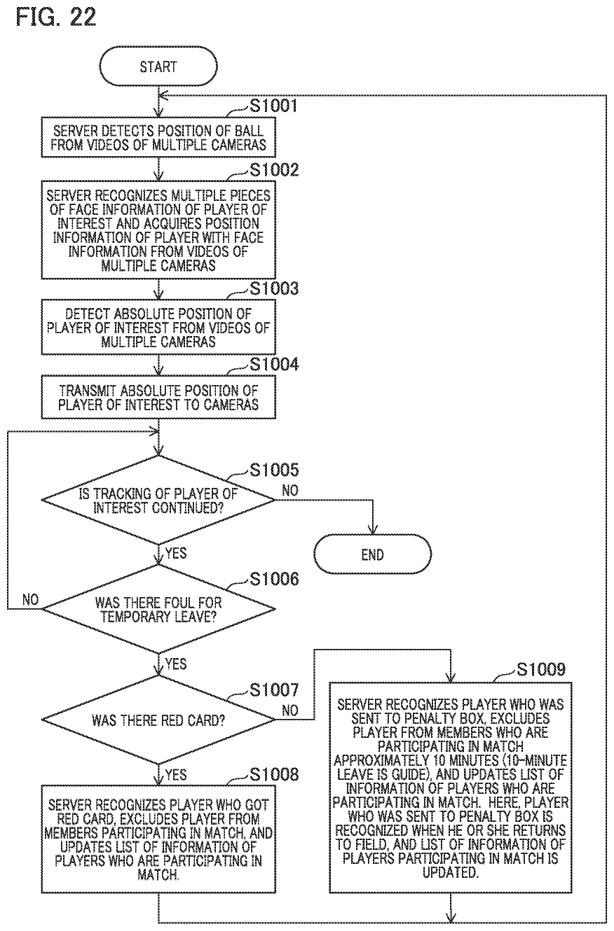

Next, a flow to detect whether a player of interest has committed a foul will be described based on FIG. 22.

In the flow of FIG. 22, a foul fora penalty box, or the like is judged in, for example, a rugby game based on videos of multiple cameras, information of the player who has temporarily left is detected, and the server transmits this information to cameras possessed by professional cameramen and general spectators, and the like. Further, the player who is regarded to be sent to the penalty box is forced to leave the game for 10 minutes. Penalties vary depending on the significance of a foul when a player commits a foul, and while the red card means an immediate leave, the foul involved with the penalty box that forbids the player from participating in the game for 10 minutes at least temporarily sends the player off of the field.

The player-of-interest detection control flow (of the server side) to detect whether the player of interest has committed a foul is illustrated in FIG. 22.

In S1001 of FIG. 22, the server detects position information of the ball based on videos from multiple cameras. A position of the player is roughly estimated using the position information of the ball. Furthermore, an area in which a player is searched for using face information is recognized according to the role of the player such as forward or back (the roles of the players as starting members are recognized with their uniform numbers, and the names, uniform numbers, and roles of reserve players are recognized with player information registered in advance, the uniform numbers of the players for the match on that day, and the roles of the players). In S1002, the server recognizes multiple pieces of face information of the player of interest including the reserve player and acquires position information of the player with the face information from video information of the multiple cameras.

If the face information of the player of interest including the reserve players is found using the video from one camera among the multiple cameras, information of a shown size, angle, and further background (the field) is input, and thus the position information of the player of interest including the reserve players can be acquired.

If the face information of the player of interest including the reserve players is found likewise using videos from multiple cameras, information of a shown size, angle, and further background (the field) is input, and thus the position information of the player of interest including the reserve players can be acquired with high accuracy. In S1003, the absolute position of the player of interest including the reserve players is detected based on the input information.

In S1004, the absolute position of the player of interest detected in S1003 is transmitted to the camera terminals possessed by the professional cameramen and general spectators. Whether tracking of the player of interest is continued is determined in S1005, and if tracking of the player of interest is continued, the process proceeds to S1006, and if tracking of the player of interest is not continued, the flow of FIG. 22 ends. Whether a foul for a temporary leave has been committed is determined in S1006, and if the foul for a temporary leave has been committed, the process proceeds to S1007, and if the foul for a temporary leave has not been committed, the process proceeds to S1005.

Whether the foul for a temporary leave is involved with the red card is determined in S1007, and if it is the red card foul, the process proceeds to S1008, and if it is not the red card foul, the process proceeds to S1009. The case where the process proceeds to S1009 is when afoul for the penalty box is committed. In S1008, the server recognizes the player who got the red card, excludes the player from the members participating in the match, and updates the list of the information of the players who are participating in the match.

In S1009, the server recognizes the player who was sent to the penalty box, excludes the player from the members who are participating in the match for 10 minutes (10-minute leave is a guide), and updates the list of the information of the players who are participating in the match. Here, the player who was sent to the penalty box is recognized when he or she returns to the field, and the list of the information of the players participating in the match is updated. Here, the player who was sent to the penalty box is recognized when he or she returns to the field, the list of the information of the players participating in the match is updated, and the process proceeds to S1001.

Further, although a situation of the match (whether a certain team is offending or defending) is determined according to a position of the ball on the premise that a role of a player is equal to a position, for example, control based on a situation of a match (situation of a game) is not limited to a position of the ball.

For example, when a certain team commits a foul, a penalty kick, or the like is given to the opposing team. In this case, the team that has gained the penalty kick is highly likely to advance from the current position of the ball in the match. Thus, control may be performed based on a situation of the match in which the team is predicted to advance. A position of the ball may be predicted based on a foul.

Furthermore, with respect to at least the foul for a temporary leave in S1006, for example, the server may recognize and detect the player committing the foul and getting out of the field with the multiple cameras.

In addition to that, there is a method of recognizing and detecting the referee's other call as audio information. In addition, the foul may be detected from the foul information displayed on the large screen.

As described above, the professional cameramen and spectators can predict the next position of the ball if they know a status of a judgment in real time. In addition, if the information of the foul is displayed on the display unit of each camera, the camera terminal side can predict the next presumed position of the ball with view of the display and capture a photo at a more opportune shutter moment.

Professional cameramen and general spectators concern judgment made in a game. A three-person referee system including one referee and two touch judges is adopted. In particular, there are cases that are hard to be judged only depending on human eyes, such as judgment in a scene in which a player seems to decide a try or judgment of a foul committed in a game. For this reason, video judgment (television match official or TMO) that is made to support the referee to make judgment when judgment with naked eyes is difficult.

When professional cameramen and general spectators photograph a scene of a try with their terminals such a cameras, the professional cameramen and general spectators want to immediately know whether the image captured at that time is admitted as a try or not admitted as a try. Thus, judgment is accurately recognized by keeping up with the subsequent judgment from videos of the multiple cameras or through analysis of the server based on information displayed on the electric signboard. Then, as the result of the judgment of the referee is transmitted to the terminals of the professional cameramen and general spectator, such as cameras, the users can correctly recognize the result of the judgment in a timely manner.

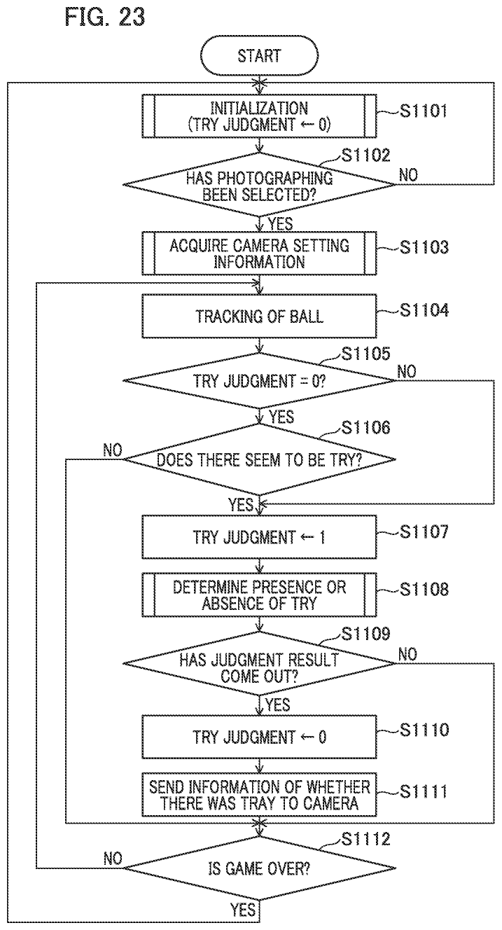

There are multiple methods for detecting whether a try is performed. A try determination control flow (of the server side) which will be described in detail below is illustrated in FIG. 23.

In FIG. 23, S1101 represents initialization. Here, a TRY judgment flag is cleared. It is determined whether photographing has been selected in S1102, and if photographing has been selected, the process proceeds to S1103, and if photographing has not been selected, the process proceeds to S1101. In S1103, camera setting information is acquired. In S1104, the ball being used in the match is tracked in videos of the multiple cameras.

In S1105, whether the TRY judgment flag is 0 is determined, if the TRY judgment flag is 0, the process proceeds to S1106, and if the TRY judgment flag is not 0, the process proceeds to S1107. Whether a try seems to have been performed is determined in S1106, and if a try seems to have been performed, the process proceeds to S1107, and if a try does not seem to have been performed, the process proceeds to S112. Here, that a try seems to have been performed means a state of a player bringing the ball in the try area.

For example, there are cases where a player commits a knock-on that the player drops the ball forward immediately before a try, or a case where a defensive player puts his hand or body for the ball for a try to stop grounding. In other words, these are a state in which a try is not confirmed. In S1107, 1 is set for the TRY judgment flag. In S1108, whether a try has been performed is determined.

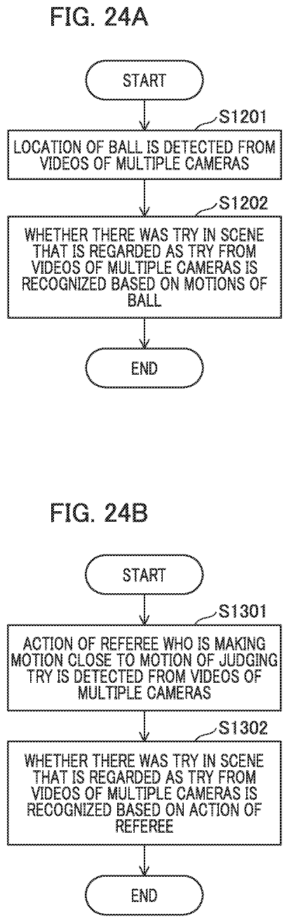

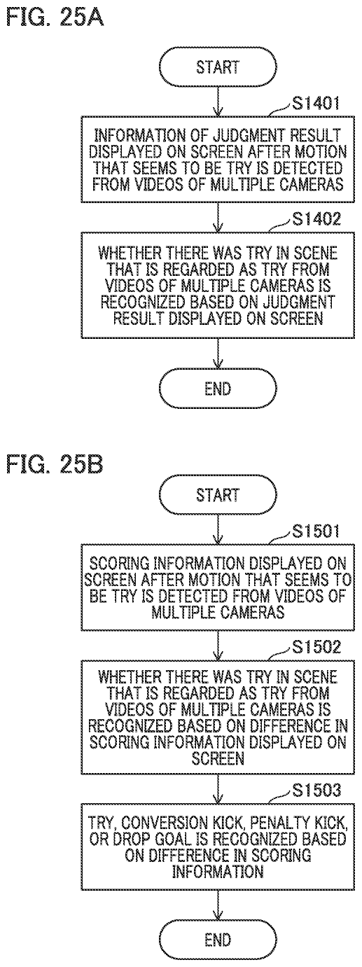

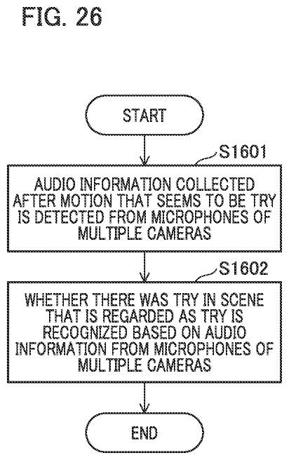

FIG. 24A and FIG. 24B, FIG. 25A and FIG. 25B, and FIG. 26 illustrate specific examples in which a try is judged, and the examples will be described later.

Whether the determination result of the presence or absence of a try has come out in the control of S1108 is determined in S1109, and if the determination result of the presence or absence of a try has come out, the process proceeds to S110, and if the determination result of the presence or absence of a try has not come out, the process proceeds to S1112. In S1110, 0 is set for the TRY judgment flag. In S1111, the server sends the information of whether there was a try to the terminals such as the cameras possessed by the professional cameramen and general spectators. Whether the game is finished is determined in S1112, and if the game is finished, the process proceeds to S1101, and if the game is not finished, the process proceeds to SI 104.

The control to determine the presence or absence of a try has been described above. However, the CPU does not perform only the control, and for example, may simultaneously perform the player-of-interest detection control illustrated in FIG. 11 in parallel.

Further, control simultaneously performed by the server in parallel is not limited thereto, and other multiple control operations may be simultaneously performed. Meanwhile, the same applies to the terminals such as the cameras possessed by the professional cameramen and general spectators, and other multiple control operations may be simultaneously performed.

When a scene of a try is photographed, whether the try succeeded or failed should be recognized correctly. The server checks the judgment of whether the try was successful or a conversion was successful. Here, the example of the try has been described. However, the control is not limited to a try, and similar control may be performed on other scenes of scoring.

When videos of the multiple cameras are analyzed and there is a play in which a try seems to have been performed, motions of the ball are analyzed with the multiple cameras, and whether the ball was surely grounded within a predetermined area is recognized. The server sends the information of whether there was a try analyzed from the recognized motions of the ball along with player information to the terminals such as the cameras possessed by the professional cameramen and general spectators.

FIG. 24A illustrates a flow of determining the presence or absence of a try on the server side using motions of the ball.

In S1201 of FIG. 24A, the server detects a location of the ball from images of the multiple cameras. In S1202, whether there was a try in a scene that is regarded as a try from the images of the multiple cameras is recognized based on the motions of the ball.

Next, FIG. 24B illustrates a try presence/absence judgment flow based on an action of the referee.

When videos of the multiple cameras are analyzed and there is a play in which a try seems to have been performed, an action of the referee near the player of interest based on rules may be then analyzed for image recognition using videos of the multiple cameras, and whether there was a try may be recognized based on the action of the referee.

The server sends the information regarding the analysis result of whether there was a try from the recognized action of the referee (action recognition result) along with the player information to the terminals such as the cameras possessed by the professional cameramen and general spectators.

In S1301 of FIG. 24B, the server detects an action of the referee who is making a motion close to the motion of judging a try from videos of the multiple cameras. In S1302, whether there was a try in a scene that is regarded as a try from the videos of the multiple cameras is recognized based on the action of the referee.

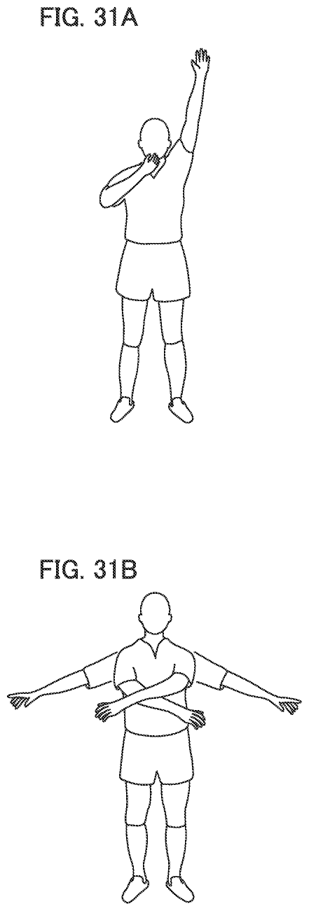

FIGS. 31A and 31B illustrate actions of a referee who is judging a try. FIG. 31A illustrates an action of the referee taken when a try is successful. FIG. 31B illustrates an action of the referee taken when a try is not successful.

Furthermore, a flow to recognize the presence/absence of a try from information displayed on the large screen of the arena will be described using FIG. 25.

When videos of the multiple cameras are analyzed and there is a play in which a try seems to have been performed, the multiple cameras input the information to be projected on the large screen of the arena, and whether there was a try may be recognized based on the information on the screen.

The server sends the information of whether there was a try analyzed from the recognized information on the screen along with player information to the terminals such as the cameras possessed by the professional cameramen and general spectators.

A try presence/absence judgment flow based on a judgment result of the server side displayed on the screen is illustrated in FIG. 25A. In S1401 of FIG. 25A, the server detects information of a judgment result displayed on the screen after a motion that seems to be a try from images of the multiple cameras. In S1402, whether there was a try in a scene that is regarded as a try from the images of the multiple cameras is recognized based on the judgment result displayed on the screen.

Next, a try presence/absence recognition flow based on scoring information displayed on the screen will be described using FIG. 25B.

When videos of the multiple cameras are analyzed and there is a play in which a try seems to have been performed, scoring information to be projected on the screen is input based on the images of the multiple cameras, and whether there was a try is recognized based on the scoring information on the screen. The server sends the information of whether there was a try analyzed from the recognized scoring information on the screen along with the player information to the terminals such as the cameras possessed by the professional cameramen and general spectators.

If a try is performed, five points will be scored, and then a conversion kick is successful, two points will be scored. In addition, if a penalty kick or a drop goal is successful, three points will be scored. Whether a try is successful can be recognized by comparing the score before a try is thought to have been performed with the score after the try is performed.

A try presence/absence judgment flow by the server based on the scoring information on the screen is illustrated in FIG. 25B.

In S1501 of FIG. 25B, the server detects the scoring information displayed on the screen after a motion that seems to be a try from images of the multiple cameras. In S1502, whether there was a try in a scene that is regarded as a try from the images of the multiple cameras is recognized based on a difference in the scoring information displayed on the screen. In S1503, a try, a conversion kick, a penalty kick, or a drop goal is recognized based on the difference in the scoring information on the screen displaying whether there was a try in a scene that is regarded as a try from the images of the multiple cameras.

Next, a flow to recognize the presence/absence of a try from audio information announced in the field will be described using FIG. 26.

When audio information input from microphones attached to the multiple cameras (fixed cameras and mobile cameras) is analyzed and there is a play in which a try seems to have been performed, whether there was a try is recognized based on the audio information from the microphones. The server sends the information of whether there was a try analyzed from the recognized audio information along with player information to the terminals such as the cameras possessed by the professional cameramen and general spectators.

A specific flow to judge presence/absence of a try by the server using audio information is illustrated in FIG. 26. In S1601 of FIG. 26, the server detects the audio information collected after a motion that seems to be a try from the microphones of the multiple cameras. In S1602, that there was a try in a scene that is regarded as a try is recognized based on the audio information from the microphones of the multiple cameras.

Although the judgment of scoring of a try has been described in the above-described example, scoring from a conversion after a try and scoring from a penalty kick may also be considered in addition to scoring from a try.

Further, although the flow to detect whether a try has been performed on the server side has been illustrated in FIG. 23, control on the terminal side such as the cameras regarding whether a try has been performed will be described.

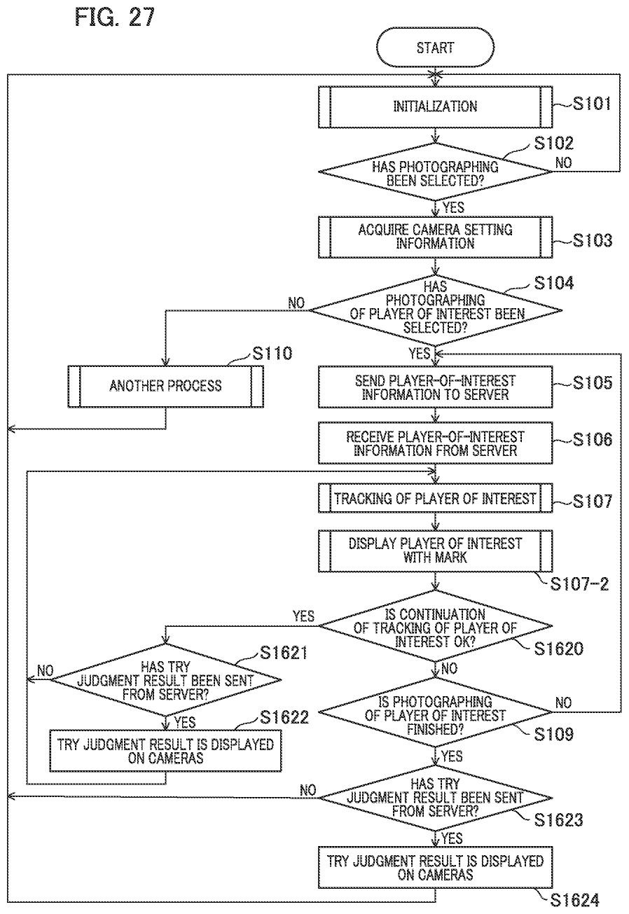

FIG. 27 illustrates a try judgment control flow of the terminal side such as a camera. Because the steps of S101 to S107-2, S109, and SI 10 in FIG. 27 are the same as those in FIG. 9, description thereof will be omitted.

Whether the continuation of tracking of the player of interest is OK (successful) is determined in S1620, and if the continuation of tracking of the player of interest is successful, the process proceeds to S1621. Whether the try judgment result has been sent from the server is determined in S1621, and if the try judgment result has been sent from the server, the process proceeds to S1622, and if the try judgment result has not been sent from the server, the process returns to S107 and the cameras themselves continue tracking of the player of interest. In S1622, the try judgment result is displayed on the display units of the cameras.

Further, if the continuation of tracking of the player of interest is not successful in S1620, the process proceeds to S109, whether photographing of the player of interest is finished is determined, and if photographing is not finished, the process returns to S105. If photographing is finished, the process proceeds to S1623, whether the try judgment result has been sent from the server is determined, if the try judgment result has been sent from the server, the process proceeds to S1624, and the try judgment result is displayed on the display units of the camera terminals. If no try judgment result has been sent from the server, the process returns to S101.

As described above, when there seems to be a try, the camera terminal side may be able to display whether the try was successful.

Thus, the general spectators or cameramen can correctly recognize the evaluation of the captured photos, for example. Then, the cameramen can recognize the judgment only by viewing the display units of the cameras, and thus they can appropriately select photos to be sent to the press and can be prepared for the next photographing earlier.

Next, judgment of afoul of a player will be described. Advantages given to the opposing team may vary depending on the level of a penalty for a foul. If a foul is serious, the yellow card is given, the penalty box is applied, and the player is forbidden from participating in the match for 10 minutes.

Furthermore, if a foul is serious and the red card is given, the player should leave the field immediately. It is important for the server to recognize the foul due to the multiple cameras, send the information to the terminals such as the cameras possessed by the professional cameramen and general spectators, and notify the processional cameramen and general spectators of the foul information along with the player information from the cameras.

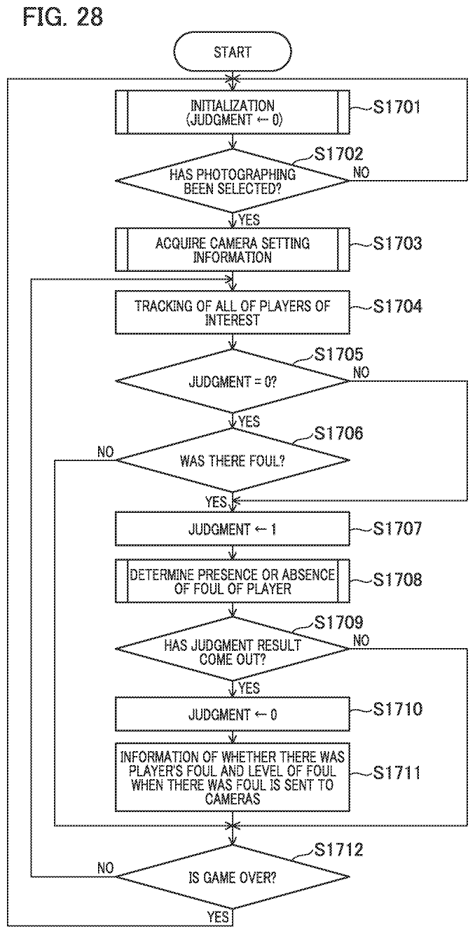

A player's foul judgment control flow of the server side for describing an example of a method for detecting whether a foul has been committed is illustrated in FIG. 28.

In FIG. 28, S1701 represents initialization. Here, a judgment flag is cleared. Next, whether photographing has been selected is determined in S1702, and if photographing has been selected, the process proceeds to S1703 to acquire camera setting information. If photographing has not been selected, the process returns to S1701. In S1704, all of the players participating in the match are tracked with the multiple cameras. Whether the judgment flag is 0 is determined in S1705, if the judgment flag is 0, the process proceeds to S1706, and if the judgment flag is not 0, the process proceeds to S1707.

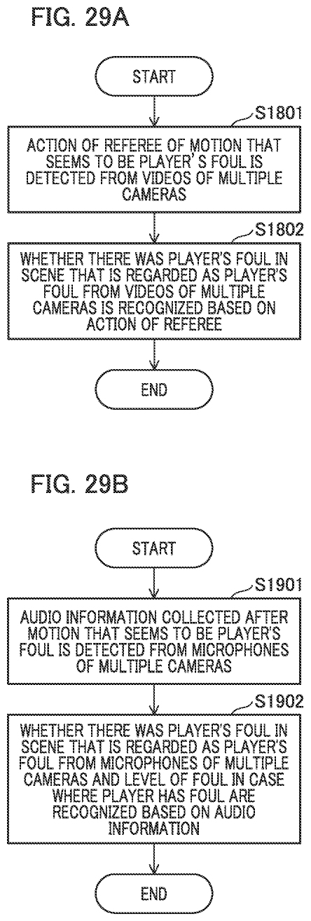

Whether a player seems to have afoul is determined in S1706, and if the player seems to have a foul, the process proceeds to S1707, and the judgment flag is set to 1. If the player does not seem to have a foul, the process proceeds to S1712. Here, a player having a foul means a player with a likelihood of having committed a foul because the play may be admitted as having committed a foul depending on a way of the player tackling against or hitting an opponent's player. In addition, there is a level in a foul even when there is a foul committed by a player. In other words, a level of the foul of the player has not been confirmed in this example. In S1708, whether there is afoul by a player is determined. FIG. 29A and FIG. 29B illustrate a specific example of a flow to judge a player's foul and details thereof will be described later.

Whether the determination result of the presence or absence of a player's foul has come out in the control of S1708 is determined in S1709, and if the determination result of the presence or absence of a player's foul has come out, the process proceeds to S1710, and if the determination result of the presence or absence of a player's foul has not come out, the process proceeds to S1712. In S1710, 0 is set for the judgment flag. In S1711, the server sends the information of whether there was a player's foul and the information of the level of the foul when there was a foul to the terminals such as the cameras possessed by the professional cameramen and general spectators.

Whether the game is finished is determined in S1712, and if the game is finished, the process proceeds to S1701, and if the game is not finished, the process proceeds to S1704.

The control to judge the presence or absence of aa player's foul has been described above. However, the flow is not for performing only the control, and other multiple control operations may be performed simultaneously or in parallel. Meanwhile, the same applies to the terminals such as the cameras possessed by the professional cameramen and general spectators, and multiple control operations may be performed simultaneously or in parallel on the terminal side.

When videos of the multiple cameras are analyzed and there is a play in which a foul seems to have been committed, an action of the referee is then analyzed using the multiple cameras, and whether there was a foul may be recognized based on the action of the referee. The server sends the information of whether there was a foul analyzed from the recognized action of the referee along with player information to the terminals such as the cameras possessed by the professional cameramen and general spectators.

FIG. 29A illustrates an example of a player's foul judgment flow of the server side based on an action of the referee. In S1801 of FIG. 29A, the server detects an action of the referee indicating that there is a player's foul from videos of the multiple cameras.

In S1802, whether there was a player's foul in a scene that is regarded as a player's foul from the videos of the multiple cameras is recognized based on the action of the referee.

Next, an example of a flow to recognize the presence/absence of a foul from audio information announced in the field will be described using FIG. 29B.

When audio information input from microphones attached to the multiple cameras is analyzed and there is a play in which a foul seems to have been committed, the audio information from the microphones is analyzed to recognize whether there was a foul from the audio information.

Then the server sends the information of whether there was a foul analyzed from the recognized audio information along with player information to the terminals such as the cameras possessed by the professional cameramen and general spectators FIG. 29B illustrates a player's foul judgment flow of the server side based on audio information. In S1901 of FIG. 29B, the server detects the audio information collected after a motion that seems to be a player's foul from the microphones of the multiple cameras. In S1902, whether there was a player's foul in a scene that is regarded as a player's foul and the level of the foul in a case where a player has are recognized based on the audio information.

Although the situation of a foul is recognized with multiple cameras (fixed cameras and mobile cameras) when the foul is committed, the information thereof is sent to the terminals such as the cameras possessed by the professional cameramen and general spectators and displayed on the terminals.

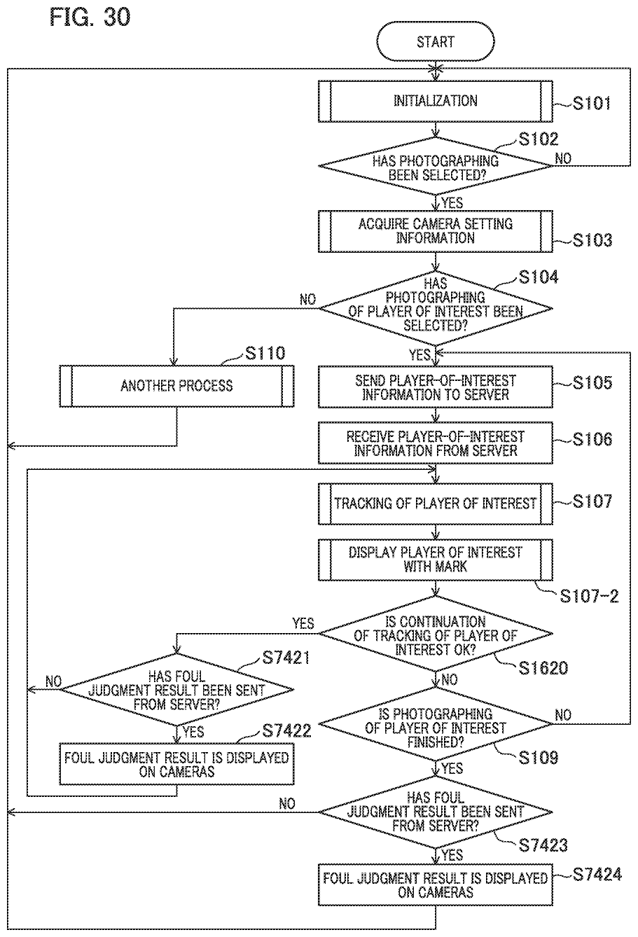

Here, FIG. 30 illustrates a foul judgment control flow of the camera side, and the situation of the foul is displayed on the camera side based on the try judgment control flow of the camera side.

Only S7421 to S7424 of FIG. 30 are different from FIG. 27. In other words, the difference is that S1621, S1622, S1623, and S1624 of FIG. 27 are replaced with S7421, S7422, S7423, and S7424, and each description of “try judgment” is changed to “foul judgment.”

According to the present example described above, the server analyzes information of the surroundings other than the player of interest (other than a specific target) and transmits the analysis result to image processing devices such as the cameras, and thus the terminal side such as the cameras can ascertain real-time situations of the game such as a try, a goal, and a foul. Thus, cameramen, and the like can gain very advantageous information particularly when they select a photo and send it to the press in a timely manner during the match. Further, motions of players may be stored in the server as big data to predict a motion of a player using AI based on the big data. Further, although the number of players of interest is specified to be only one in the example, the number of players of interest may be multiple.

In addition, a player of interest is assumed to be switched in the middle of a game. Players of interest may be all players participating in a match. In addition, videos and images are assumed to include not only moving images but also still images. In addition, tracking of the player of interest has been mainly described. However, without tracking only the player of interest, information of a player having the ball or receiving the ball may be transmitted to professional cameramen and spectators and displayed.

In addition, although the example in which the player is tracked has been described in the example, it is needless to say that the embodiment can be applied to a system in which a person such as a criminal is tracked using multiple surveillance cameras, or the like. Alternatively, the embodiment can be applied to a system for tracking a specific car, or the like in car racing, a system for tracking a horse in horse racing, and the like, without being limited to tracking a person. Further, although the example in which the player of interest is specified with a camera terminal, or the like has been described in the example, the server side may be able to specify, the player of interest.

Further, if a determination is made further focusing on the role of the player including reserve players when the face of the player is recognized, the detection of the player by the server can be shortened, and further accuracy in detection of the player including reserve players can be improved.

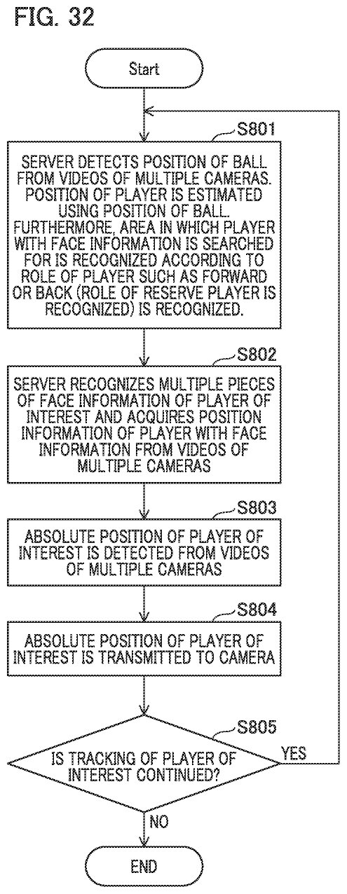

An example of a flow of player-of-interest detection control including reserve players of this case is illustrated in FIG. 32.

In S801 of FIG. 32, the server detects position information of the ball from videos from multiple cameras. A position of the player of interest is roughly estimated using the position information of the ball. Furthermore, an area in which the player of the face information is searched for is recognized according to the role of the player such as forward or back (the roles of players as starting members are recognized with their uniform numbers, and with respect to a reserve player, the name, uniform number, and role of the reserve player are recognized with player information registered in advance, the uniform number of the player for the match on that day, and the role of the player).

In S802, the server recognizes the face information of the player of interest including the reserve player in the area recognized in S801 and acquires position information of the player with the face information with the input of video information of the multiple cameras.

If the face information of the player of interest including the reserve player is found using the video from each of the multiple cameras, information of a shown size, angle, and further background (the field) is input, and thus the position information of the player of interest including the reserve player can be acquired. If the face information of the player of interest including the reserve player is found likewise using the videos from the multiple cameras, information of a shown size, angle, and further background (the field) is input, and thus the accuracy in the position information of the player of interest including the reserve player can be improved.

In S803, absolute position of the player of interest is detected based on the position of the player of interest acquired from the video information of the multiple cameras detected in S802. In S804, the absolute position of the player of interest detected in S803 is transmitted to the camera terminals possessed by the professional cameramen and general spectators.

Whether tracking of the player of interest is continued is determined in S805, and if tracking of the player of interest is continued, the process proceeds to S801, and if tracking of the player of interest is not continued, the flow of FIG. 32 ends.

Here, although a situation of a match or a game (whether a certain team is offending or defending) is determined based on a position of the ball, for example, control based on a situation of the match is not limited to a position of the ball. For example, when a certain team commits a foul, a penalty kick, or the like is given to the opposing team. In this case, the team that has gained the penalty kick is highly likely to advance from the current position of the ball in the match. Thus, control may be performed based on a situation of the match in which the team is predicted to advance. A position of the ball may be predicted based on a foul as described above.

Information of a player change may be recognized based on videos of the camera for the multiple servers, and thus information of the player going out of the field and the player going in the field (including the positions of the players) may be recognized. In addition, the server sends the information to the camera terminals possessed by the professional cameramen and general spectators. The position from which the player goes in the field at the time of the player change is tracked and at the same time is notified to the camera terminals possessed by the professional cameramen and general spectators.

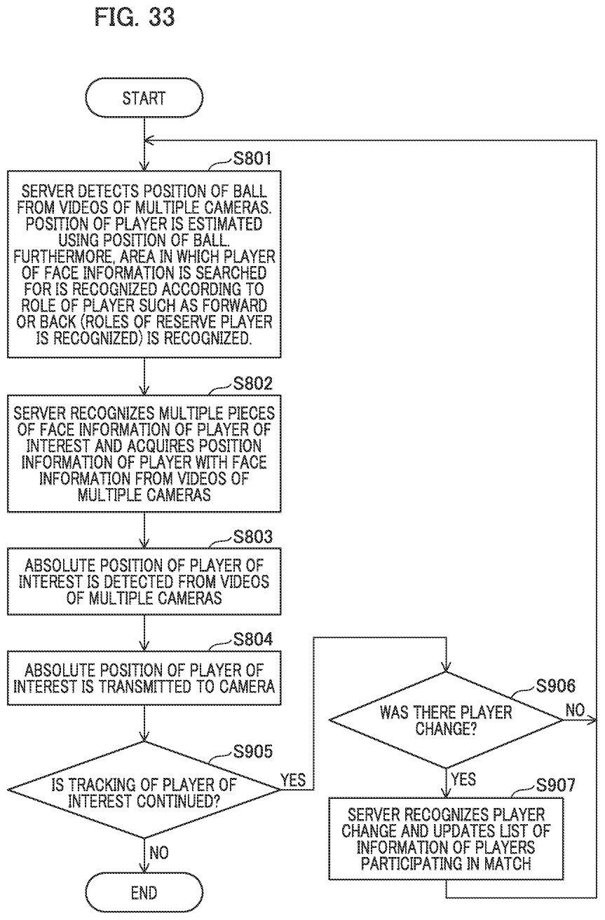

A method of supporting player detection in the player change based on reserve player detection control will be described using FIG. 33. A flow to detect a focused player including a reserve player using face recognition information considering the role (position) of the player at the time of a player change is illustrated in FIG. 33.

Reference numerals in FIG. 33 the same as those in FIG. 32 represent the same steps, and description thereof will be omitted.

Whether tracking of the player of interest is continued is determined in S905, and if tracking of the player of interest is continued, the process proceeds to S906, and if tracking of the player of interest is not continued, the control ends. Whether a player change has been made is determined in S906, and if a player change has been made, the process proceeds to S907, and if a player change is not made, the process proceeds to S801. In S907, the server recognizes the player change, and updates a list of information of players participating in the match.

Here, although a situation of a match (whether a certain team is offending or defending) is determined based on a position of a ball, for example, control based on a situation of a match is not limited to a position of a ball. For example, when a certain team commits a foul, a penalty kick, or the like is given to the opposing team. In this case, the team that has gained the penalty kick is highly likely to advance from the current position of the ball in the match. Thus, control may be performed based on a situation of the match in which the team is predicted to advance. A position of the ball may be predicted based on a foul as described above. Furthermore, with respect to the player change in S906, for example, the server may recognize and detect the player going out of the field and the player going in the field with the multiple cameras.

In addition to that, there is a method of recognizing and detecting the referee's other call as audio information. In addition, there is a method of detecting a player from player change information displayed on the large screen. Furthermore, a player may be detected from a list of members displayed on the large screen.

When a player of interest is detected, information of the player who committed a foul for the penalty box or the like and temporarily leaves the field may be detected from videos of the camera for the multiple servers.

In addition, the server sends the information to the camera terminals possessed by the professional cameramen and general spectators. The player who is liable for the penalty box is forbidden from participating in the match for 10 minutes.

In the example of FIG. 33, information of a player change is recognized based on videos of the multiple cameras, and thus information of the player going out of the field and the player going in the field (including the positions of the players) is recognized. In addition, the server sends the information to the camera terminals possessed by the professional cameramen and general spectators. The position from which the player goes in the field at the time of the player change is tracked and at the same time is notified to the camera terminals possessed by the professional cameramen and general spectators.

However, a player needs to leave the field in a case other than a player change. Penalties vary depending on the significance of a foul when a player commits a foul, and a foul involved with the red card that means an immediate leave and the penalty box that forbids the player from participating in the game for 10 minutes makes the player temporarily leave the field. Thus, for the method of supporting detection of a player in a player change and detection of a player who committed a foul based on catching a reserve player, the focused player detection control flow as in FIG. 22 is used.

In the present example, the player of interest is registered in advance, the location of player of interest is displayed on the display unit of the camera with a mark attached thereto, and further auto-focusing (AF) is adjusted for the player of interest. Accordingly, there is an advantage for the professional cameramen and general spectators to photograph the player of interest quickly.

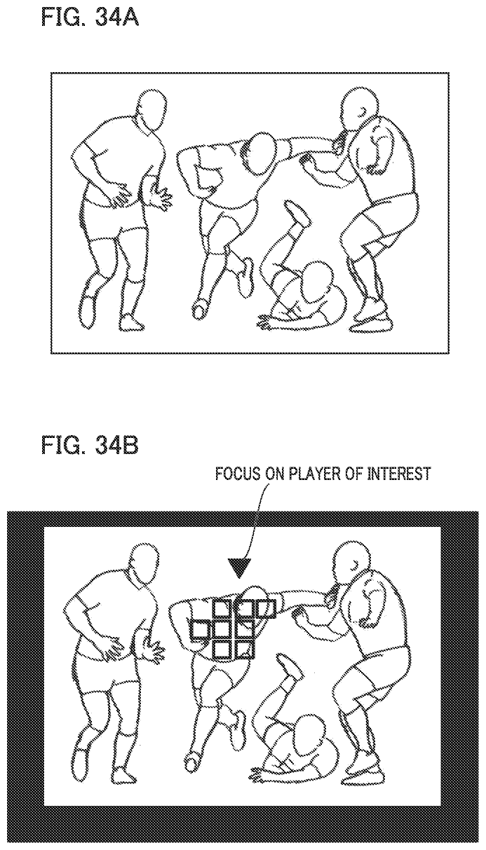

FIGS. 34A and 34B are diagrams illustrate the display unit on the camera side with respect to auto-focusing (AF) for a player of interest. In FIG. 34, as a player of interest, the player who is committing handoff at the center of FIG. 34A is registered. The camera performs auto-focusing (AF) on the player of interest. The video that the photographer views from the display unit of the camera is FIG. 34B, and auto-focusing (AF) is performed on the player of interest, and thus photographing can be performed with no photo opportunities missed. Further, exposure may be automatically adjusted for the player of interest at this time.

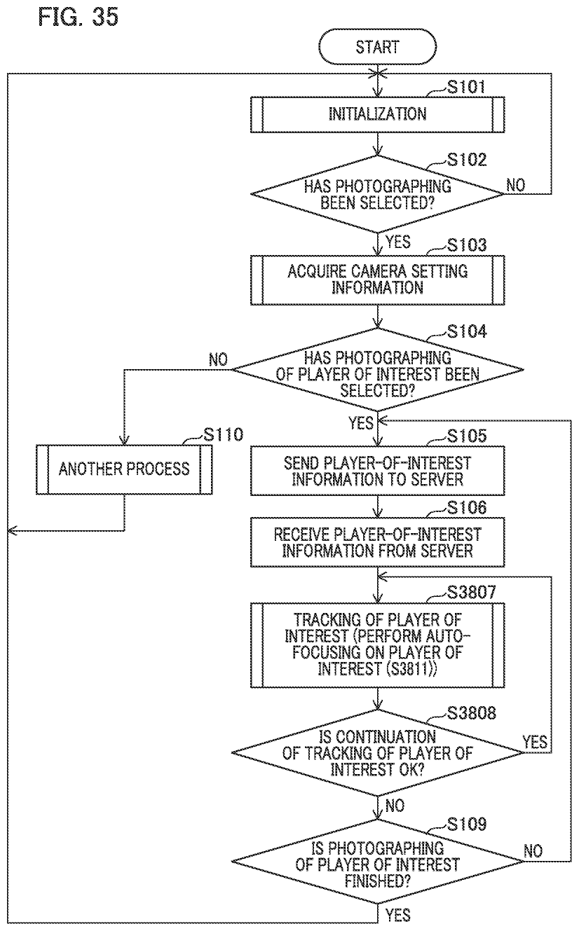

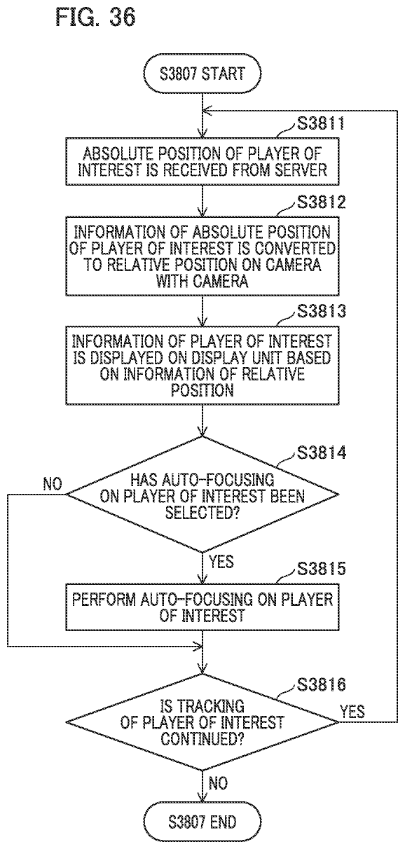

Next, FIGS. 35 and 36 illustrate a flow of AF for a player of interest in focused player display tracking control of the camera side. Reference numerals the same as those in FIG. 8 represent the same steps, and description thereof will be omitted.

In S3807 of FIG. 35, tracking of the player of interest is performed by the camera itself based on position information of the player of interest.

At this time, auto-focusing (AF) is performed on the player of interest with a mark attached to the player of interest on the display unit. Whether the continuation of tracking of the player of interest is OK (successful) is determined in S3808, and if the continuation of tracking of the player of interest is successful, the process proceeds to S3807, and tracking of the player of interest is continuously performed by the camera itself, and if the continuation of tracking of the player of interest is not successful, the process proceeds to S109.

FIG. 36 illustrates details of the flow of S3807. In S3811 of FIG. 36, the camera receives absolute position information of the player of interest from the server. In 3812, the camera converts the absolute position information of the player of interest to relative position information based on the position, the direction, the magnification, and the like for photographing of the camera. In S3813, the information of the player of interest is displayed on the display unit based on the information of the relative position viewed from the camera. In S3814, the information from the operation unit input section 906 as an input unit is input to determine whether a mode in which auto-focusing (AF) for the player of interest is performed based on the position information from the server has been selected.

Then, if auto-focusing (AF) for the player of interest has been selected, the process proceeds to S3815, and if auto-focusing (AF) for the player of interest has not been selected, the process proceeds to S3816. Further, it is assumed that, if auto-focusing (AF) for the player of interest has not been selected. AF or AE is performed according to a frame displayed at the center within the display screen or the like of the camera regardless of position information of the player of interest.

Further, a known method may be applied to the method of auto-focusing (AF) for S3815, and description thereof will be omitted. In addition, exposure may be adjusted for the player of interest in S3815. Whether tracking of the player of interest is continued is determined in S3816, and if tracking of the player of interest is continued, the process proceeds to S3811, and if tracking of the player of interest ends, the flow of FIG. 36 ends.

With the control described above, the camera terminals of the professional cameramen and general spectators not only can recognize the player of interest but also perform AF and AE for the player of interest quickly, and thus photographing can be performed in a timely manner.

Further, a unit to select a player-of-interest auto-tracking mode may be provided on the camera side. Here, if the player-of-interest auto-tracking mode is selected, the camera places the player of interest on the screen of the display unit using the automatic zoom function. Thus, the professional cameramen and general spectators can use the mode more easily.

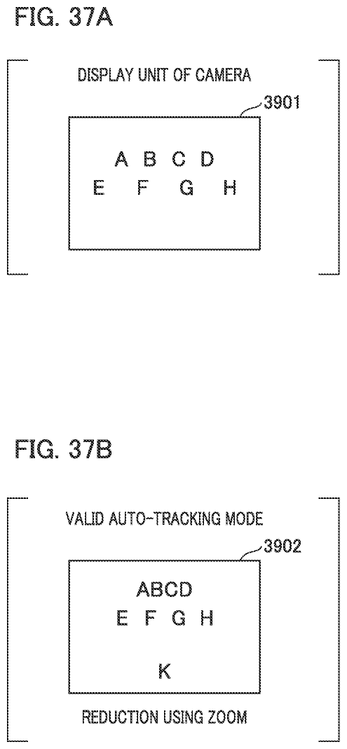

FIGS. 37A and 37B illustrate examples of displays of the camera display unit at the time of auto-tracking.

In FIG. 37A, 3901 represents the display unit of a camera. In 3901, seven players including A, B, C, D, E, F, G, and H are placed in the photographing area of the camera of a professional cameraman or general spectator. Here, the player of interest is K and is outside of the photographing area of the camera.

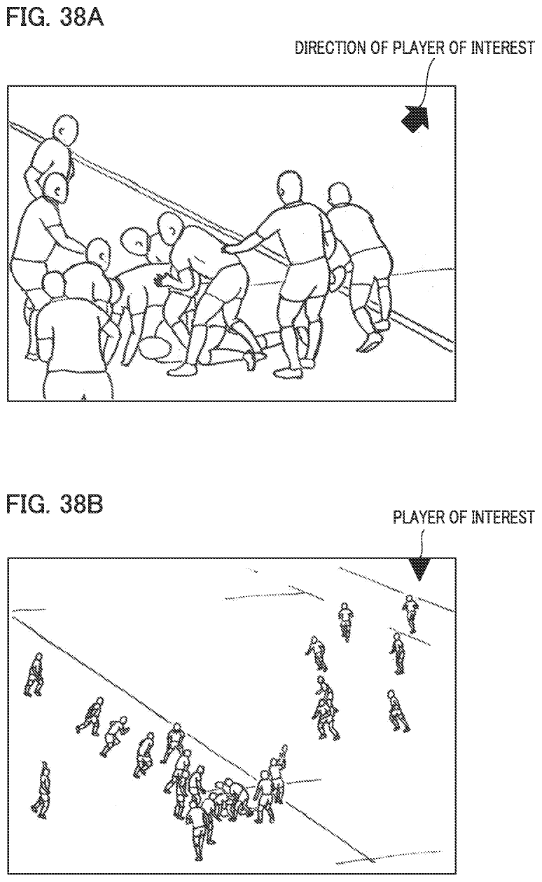

In FIG. 37B, 3902 represents a zoom-out state of the display unit of the camera when the auto-tracking mode is turned on. The camera automatically has a wide angle due to the zoom function, and control to place the player of interest K in the photographing area is performed. FIGS. 38A and 38B are diagrams illustrating more specific display examples, and in FIG. 38A, the player of interest being outside of the display screen is indicated by an arrow overlapped on the display pointing the arrow direction while a live view image from the image sensor is displayed. In addition, a case in which the zoom becomes wide due to the auto-tracking mode is illustrated in FIG. 38B. Here, an arrow indicates the position of the player of interest in the screen. Because the player of interest is placed within the display screen, a situation of a game can be easily ascertained, and an image that the user wants to capture can be easily obtained.

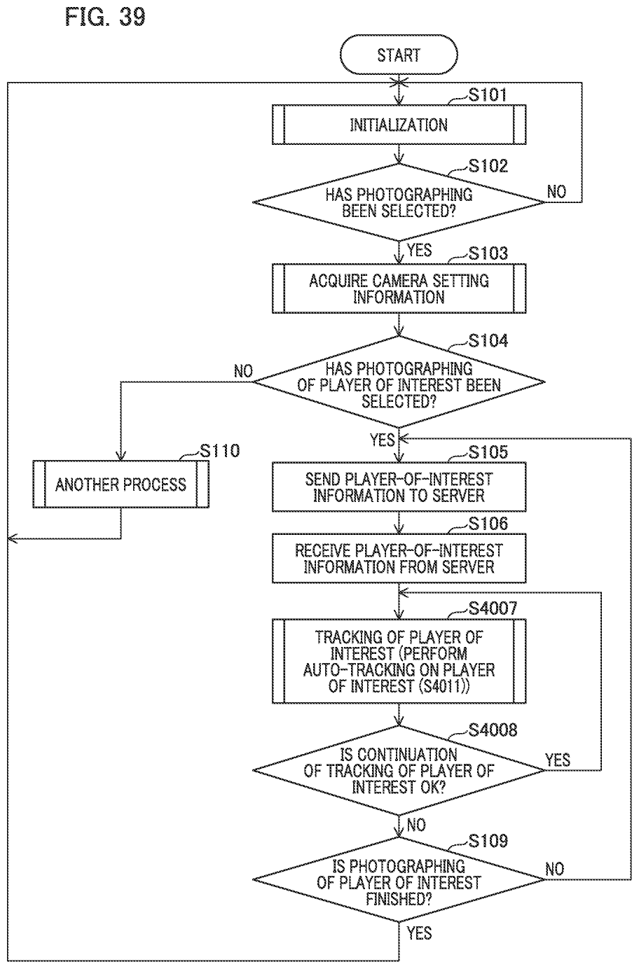

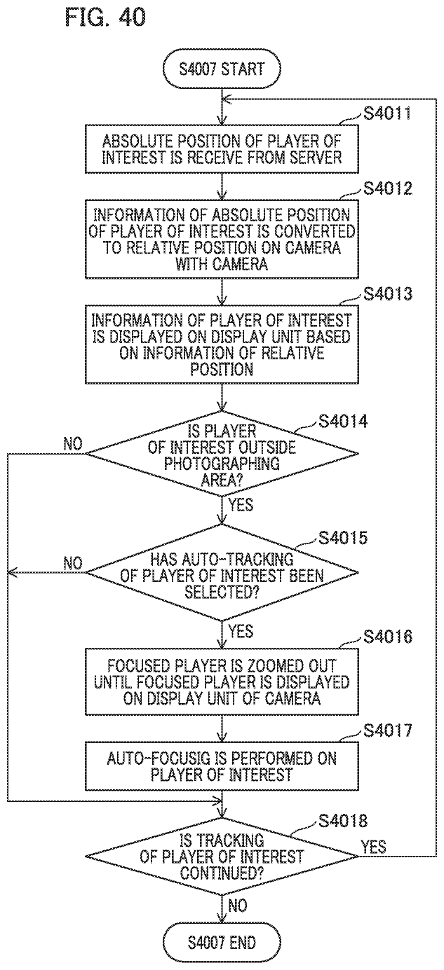

FIGS. 39 and 40 illustrate a focused player display tracking control flow of the camera side, in other words, a flow at the time of the auto-tracking mode for the player of interest.

Reference numerals in FIG. 39 the same as those in FIG. 8 represent the same steps, and description thereof will be omitted. In S4007 of FIG. 39, the player of interest is tracked by the camera itself. Further, if the auto-tracking mode is selected by the operation unit, auto-tracking of the player of interest is performed, and if the auto-tracking is not selected, auto-tracking is not performed. In auto-tracking of the player of interest by the camera terminal possessed by the professional cameraman or general spectator, a zoom magnification is automatically controlled so that the player is zoomed out and placed within the screen of the display unit of the camera when the player is not within the area of the camera. The control of S4007 is illustrated in FIG. 40 in detail and will be described below.

Whether the continuation of tracking of the player of interest is successful (OK) is determined in S4008, and if the continuation of tracking of the player of interest is successful, the process proceeds to S4007 and tracking of the player of interest is continuously performed by the camera itself, and if the continuation of tracking of the player of interest is not successful, the process proceeds to S109.

Next, S4007 will be described in detail based on FIG. 40. In S4011 of FIG. 40, the camera receives absolute position information of the player of interest from the server. In S4012, the camera converts the absolute position information of the player of interest to relative position information based on the position, the direction, the magnification, and the like for photographing of the camera.

In S4013, the information of the player of interest is displayed on the display unit based on the information of the relative position viewed from the camera. Whether the player of interest is outside of the photographing area of the camera is determined in S4014. If the player of interest is outside of the photographing area of the camera (outside a display image), the process proceeds to S4015, and if the player of interest is inside the photographing area of the camera (inside the display image), the process proceeds to S4018. In S4015, the information from the operation unit input section 906 is input to determine whether the player-of-interest auto-tracking mode has been selected by the user.

If the player-of-interest auto-tracking mode has been selected, the process proceeds to S4016, and if the player-of-interest auto-tracking mode has not been selected, the process proceeds to S4018. In S4016, the player is zoomed out to a wide angle until the focused player is displayed on the display unit of the camera. In S4017, auto-focusing (AF) for the player of interest is performed. At this time, AE is also performed so that the player of interest is appropriately exposed. Whether tracking of the player of interest is continued is determined in S4018, and if tracking of the player of interest is continued, the process proceeds to S4011, and if tracking of the player of interest ends, the flow of FIG. 40 ends.

As described above, a video of the entire field of the game is read by the server, and the location from which photographing started is ascertained from the video captured by the professional cameraman and general spectator. The server can gain videos of the entire field from the multiple cameras and can map the position information of the field to the video viewed by the professional cameraman and general spectator. In addition, when the camera of the professional cameraman and spectator receives the absolute position information of the player of interest from the server, the absolute position information can be mapped to the video being captured now. In other words, the camera of the professional cameraman and general spectator can recognize the player of interest and take photos in a timely manner.

Here, if the focused player is not within the photographing area of the camera, zoom is adjusted to a wide angle and control is performed such that the player of interest is placed within the photographing area of the camera. Furthermore, because the camera automatically adjusts focus and exposure for the player of interest, cameras of professional cameramen and general spectators can capture a video in which the player of interest is focused quickly and reliably.

Furthermore, because automatic exposure (AE) is automatically performed in addition to auto-focusing (AF), an optimum image is obtained with no need to wait for adjustment by the user. Further, only AE may be performed, without AF. Furthermore, the user may be able to selectively turn off control of one of AF and AE using a selection switch, which is not illustrated.

As described above, in a game of rugby, soccer, or the like, players dodges the opponents by making steps that are difficult to predict, and thus keep tracking the player of interest is very difficult. The present example has advantages that keeping tracking the player is possible in such a case or re-detection/re-tracking can be performed soon even when the player of interest is lost to sight. Furthermore, in a game of rugby, soccer, or the like, player carrying the ball change one after another. At this time, players of interest photographed by cameramen change one after another. In this case, for example, there is a method of tracking the player carrying the ball.

The server may ascertain the current situation in the field and predict an incident that may occur next. Then, the server sends the information of the prediction to the camera terminals possessed by the professional cameramen and general spectators. The information of the prediction is displayed on the camera terminals possessed by the professional cameramen and general spectators. The professional cameramen and general spectators can gain photo opportunities more surely by viewing this information.

As one specific example of the prediction function, a case in which a player change is looked ahead will be described.

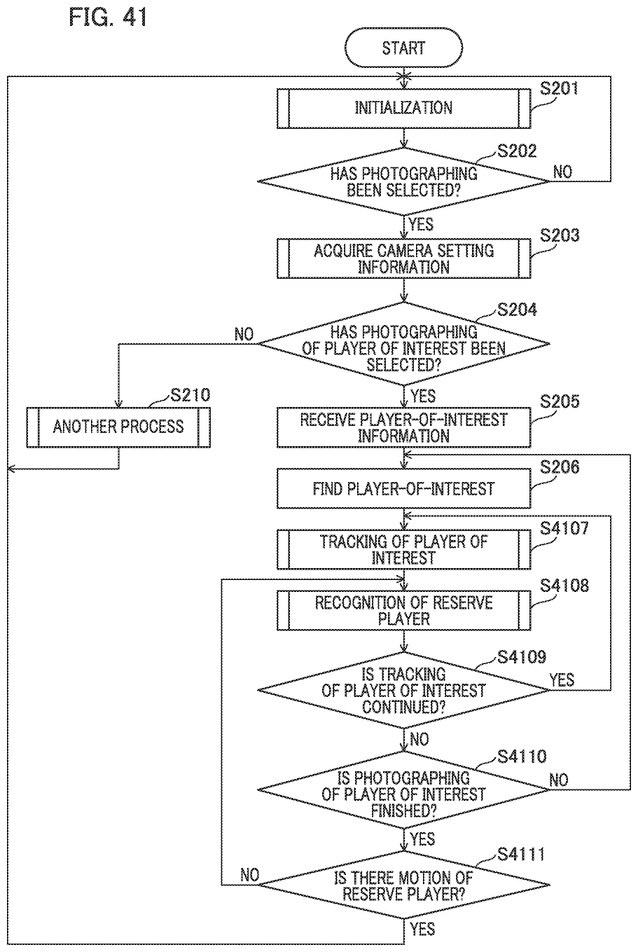

The server determines (analyzes) a situation of a match (a situation of a game) using the camera for the multiple servers, looks ahead to what will happen next, and transmits information based on the operation to the camera terminals possessed by the professional cameramen and general spectators. In rugby, the possibility of a player change is high when a player is injured, or the like. Thus, a focused player change detection control flow in which a timing for a player change is predicted based on a preparation state of a reserve player is illustrated in FIG. 41.

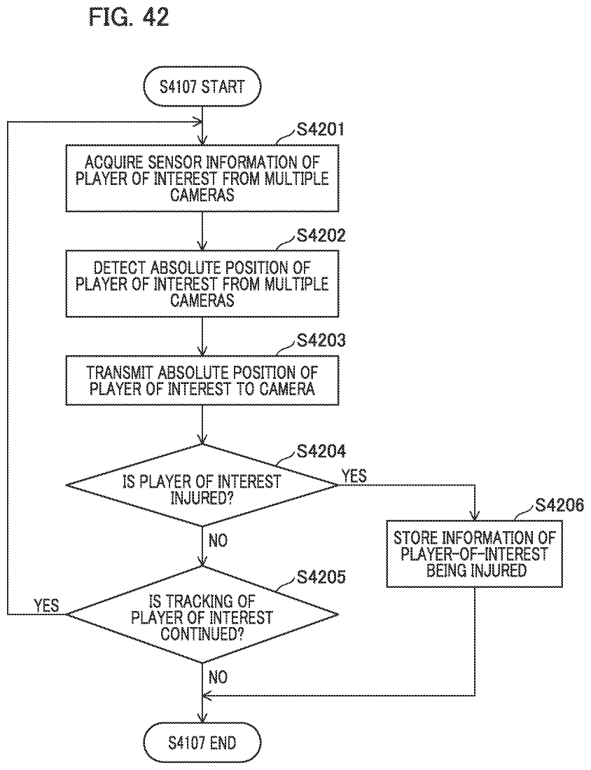

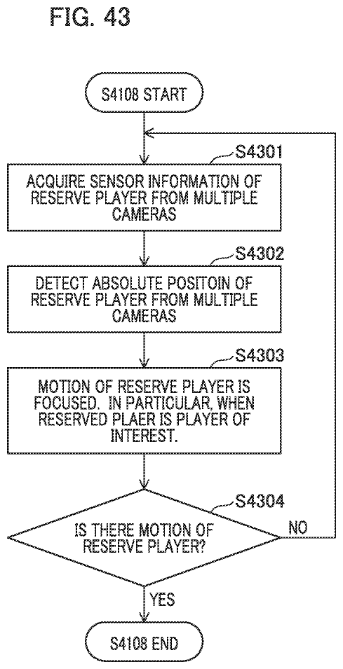

Reference numerals in FIG. 41 the same as those in FIG. 11 represent the same steps, and description thereof will be omitted. In S4107, the player of interest is tracked. A specific flow will be described using FIG. 42. In S4108, a reserve player is recognized. Details of S4108 will be described below in FIG. 43. Whether tracking of the player of interest is continued is determined in S4109, and if tracking of the player of interest is continued, the process proceeds to S4107, and if tracking of the player of interest is not continued, the process proceeds to S4110.

Whether the photographing of the player of interest is finished is determined in S4110, and if the photographing of the player of interest is finished, the process proceeds to S4111, and if the photographing of the player of interest is not finished, the process proceeds to S206. Whether there is a motion of the reserve player is determined in S4111, and if there is a motion of the reserve player, the process proceeds to S201, and if there is no motion of the reserve player, the process proceeds to S4108.

Next, the flow of S4107 will be described using FIG. 42.

In this example, it is assumed that the player himself or herself allows a position sensor to be installed in the cloth such as the uniform or the player wears a position sensor using a belt or the like around his or her arm, waist, leg, or the like. In addition, the server recognizes a signal from the position sensor of the player when the position sensor wirelessly sends information to the server side using the communication unit to generate position information, and the server notifies terminals such as the cameras possessed by the professional cameramen and general spectators of the position information.

In S4201 of FIG. 42, the server acquires the information of the position sensor of the player of interest from the multiple cameras. Each of the multiple cameras include a detection unit that receives radio waves from the position sensor, detects the direction of the radio waves being received and the level of the radio waves being received, and outputs the factors as information of the position sensor. The absolute position of the player of interest is detected based on the information of the position sensor from the multiple cameras in S4202. In S4203, the information of the absolute position of the player of interest is transmitted to the camera terminals possessed by the professional cameramen and general spectators. Whether the player of interest is injured is determined in S4204, and if the player of interest is injured, the process proceeds to S4206, and the fact that the player of interest is injured is stored in a storage unit such as the data memory 213.

The process proceeds to S4205 if the player of interest is not injured Whether tracking of the player of interest is continued is determined in S4205, and if tracking of the player of interest is continued, the process proceeds to S4201, and if tracking of the player of interest is not continued, the flow of FIG. 42 ends.

The reserve player recognition control flow of S4108 is illustrated in FIG. 43.

In S4301 of FIG. 43, the server acquires the information of the position sensor of the reserve player from the multiple cameras. The information of the position sensor also includes the direction of radio waves being received and the level of the radio waves being received.

The absolute position of the reserve player is detected based on the information of the position sensor from the multiple cameras in S4302. In S4303, a motion of the reserve player is focused. In particular, if the player of interest is the reserve player, attention is paid to his or her motion. Whether there is a motion of the reserve player is determined in S4304, and if there is a motion of the reserve player, the flow of FIG. 43 ends, and if there is no motion of the reserve player, the process proceeds to S4301.

If an interception of a player, or the like can be predicted, the photo opportunities can be reliably used. In other words, if professional cameramen and general spectators can photograph a motion of an unexpected player, they can capture a highly valuable photo.

In addition, when the ball was hit in baseball, for example, a player change may be predicted based on statistical data such as an increasing possibility of pitcher change.

Motions of players may be stored in the server as big data to predict a motion of a player using AI based on the big data.

Although the number of players of interest is one in the example, the number of players of interest may be multiple. In addition, a player of interest is assumed to be switched in the middle of a game.

In addition, videos are assumed to include not only moving images but also still images in the above description.

In the above-described example, the position of the player of interest can be displayed on the terminal side such as the cameras in a timely manner, and thus spectators and cameramen can photograph the player of interest with no photo opportunities missed.

Further, specification of the player of interest is assumed to be switched in the middle of a game. Players of interest may be all players participating in a match. In addition, videos and images are assumed to include not only moving images but also still images. In addition, tracking of the player of interest has been mainly described. However, without tracking only the player of interest, information of a player having the ball or receiving the ball may be transmitted to professional cameramen and spectators and displayed.

In addition, although the example in which rugby players, and the like are tracked has been described in the example, players of other sports may be tracked, and it is needless to say that the embodiment can be applied to a system in which a specific person such as a criminal is tracked using multiple surveillance cameras, or the like. Alternatively, the embodiment can be applied to a system for tracking a specific car, or the like in car racing, a system for tracking a horse in horse racing, and the like, without being limited to tracking a person. Further, although the example in which the player of interest is specified with a camera terminal, or the like has been described in the example, the server side may be able to specify the player of interest.

In addition, for example, although there are many cases in which privilege is given to some spectator, sponsors, and the like in international games of the Olympics, the World Cup, and the like, a level of additional values provide can be changed depending on the level of privilege and contract in the example. Control depending on such a level can be realized by inputting a password, or the like, and a professional cameraman who made a special contract can acquire highly valuable videos and various kinds of information of the inside and outside of the ground by inputting the password, and thus can photograph good photos.

As described in the above, according to the Embodiment, if a user specifies his or her specific target being aimed at, it is easy for the user to ascertain where the specific target is on the screen and difficult for the user to lose sight of the specific target when he or she is, for example, monitoring or photographing the specific target.

While the present disclosure has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

A computer program that realizes some or all of the types of control in the present disclosure as functions of the above-described Embodiment may be supplied to an image processing apparatus or the like via a network or various storage media. Then, a computer (or a CPU, an MPU, or the like) in the image processing apparatus or the like may read and execute the program. In that case, the program and a storage medium storing the program fall within the present disclosure.

What is claimed is:

1. An image processing device comprising,
at least one processor or circuit configured to function as:
a display unit configured to display an image;
a selection unit configured to select a specific target from the image displayed on the display unit;
a specification information generation unit configured to generate specification information of the specific target selected by the selection unit;
a transmission unit configured to transmit the specification information generated by the specification information generation unit to a server;
an acquisition unit configured to acquire position information of the specific target from the server based on the specification information; and
a control unit configured to cause the display unit to display additional information based on the position information of the specific target acquired by the acquisition unit.

2. The image processing device according to claim 1, wherein the control unit causes a position of the specific target within a display screen of the display unit to be displayed as the additional information based on the position information.

3. The image processing device according to claim 1, wherein the server recognizes the specific target in a video, generates position information of the specific target based on the recognition result, and transmits the position information to the image processing device.

4. The image processing device according to claim 2, wherein the server recognizes an image of the specific target, generates position information based on the recognition result, and transmits the position information to the image processing device.

5. The image processing device according to claim 2, wherein the server generates position information of the specific target based on a result obtained by recognizing a signal from a position sensor worn by the specific target.

6. The imaging processing device according to claim 5, wherein the additional information includes at least one of a cursor and an area having a different color or luminance.

7. The image processing device according to claim 1, wherein the additional information indicates in which direction the specific target is present when viewed from the screen when the specific target is outside of the screen.

8. The image processing device according to claim 1, wherein the additional information indicates a degree at which the specific target deviates from the screen.

9. The image processing device according to claim 8, wherein the additional information indicates how far the specific target deviates from the screen using a length or a thickness of an arrow.

10. The image processing device according to claim 8, wherein the additional information indicates how far the specific target deviates from the screen using a number or a scale.

11. The image processing device according to claim 4, wherein the server recognizes a number worn by the specific target and a part or the entire shape of the specific target.

12. The image processing device according to claim 1, wherein the server generates position information of the specific target based on a result obtained by recognizing an image of the specific target of videos of multiple cameras and transmits the position information to the image processing device.

13. The image processing device according to claim 1, further comprising:
a tracking unit configured to track the specific target after the position information of the specific target is acquired from the server.

14. The image processing device according to claim 1, wherein, when tracking by the tracking unit fails, the transmission unit requests transmission of the position information with respect to the server.

15. The image processing device according to claim 14, wherein, when it is predicted that the image processing device will fail in tracking the specific target, the server notifies the image processing device of position information of the specific target without waiting for the request from the image processing device.

16. The image processing device according to claim 1, wherein the server acquires in advance a video of the entire field in which the specific target is present and generates the position information.

17. The image processing device according to claim 16, wherein the server generates relative position information when the specific target is viewed from the image processing device based on the position information of the specific target in the field.

18. The image processing device according to claim 17, wherein the server transmits first position information of the specific target in the field to the image processing device, and the image processing device generates relative position information when the specific target is viewed from the image processing device based on the first position information.

19. The image processing device according to claim 1, wherein the selection unit selects multiple specific targets.

20. The image processing device according to claim 1, wherein an image displayed on the display unit is a live view image obtained by a photographing unit, and the additional information is overlaid on the live view image and displayed based on the position information.

21. An image processing device comprising,
at least one processor or circuit configured to function as:
a display unit configured to display an image;
a selection unit configured to select a specific target from the image displayed on the display unit;
a specification information generation unit configured to generate specification information of the specific target selected by the selection unit;
a transmission unit configured to transmit the specification information generated by the specification information generation unit to a server;
an acquisition unit configured to acquire position information of the specific target from the server based on the specification information; and
a control unit configured to cause the specific target to be displayed as being out of a screen of the display unit if a position of the specific target is outside of the screen based on the position information of the specific target acquired by the acquisition unit.

22. The image processing device according to claim 21, wherein the control unit causes a direction in which the specific target is outside of the screen of the display unit to be displayed if the specific target is outside of the screen.

23. The image processing device according to claim 21, wherein the control unit causes a degree at which the specific target deviates from the screen of the display unit if the specific target is outside of the screen.

24. The image processing device according to claim 1, wherein the server analyzes a video from a camera, recognizes a movement of the specific target, generates movement recognition results, and transmits the movement recognition results to the image processing device.

25. The image processing device according to claim 24, wherein the movement recognition result includes a result of judging a movement by the specific target according to a predetermined rule in a predetermined sport.

26. The image processing device according to claim 24, wherein the movement recognition result includes a recognition result of a movement relating to scoring in a predetermined sport.

27. The image processing device according to claim 24, wherein the movement recognition result includes a recognition result of a movement relating to a foul in a predetermined sport.

28. The image processing device according to claim 1, wherein the server analyzes information of surroundings other than the specific target based on a video from a camera and transmits the analysis result to the image processing device.

29. The image processing device according to claim 28, wherein the server analyzes a video, generates a movement recognition result based on a result obtained by recognizing a movement of a target other than the specific target, and transmits the movement recognition result to the image processing device.

30. The image processing device according to claim 29, wherein the movement recognition result includes a recognition result relating to a movement of a referee in a predetermined game.

31. The image processing device according to claim 1, wherein the server analyzes information of surroundings other than the specific target based on sound accompanying a video and transmits the analysis result to the image processing device.

32. The image processing device according to claim 1, wherein the selection unit selects the specific target through image recognition by a user selecting an image of the specific target from images displayed on the display unit.

33. The image processing device according to claim 32, wherein the specification information generation unit generates specification information of the specific target based on a result obtained by recognizing the image of the specific target selected by the selection unit.

34. The image processing device according to claim 1, wherein the server generates information of a position of the specific target based on a predetermined reference index in videos of the multiple cameras and transmits the information to the image processing device.

35. The image processing device according to claim 34, wherein the reference index includes a pole or a line provided in an arena in advance.

36. The image processing device according to claim 1, wherein the control unit controls at least one of exposure adjustment or focus adjustment on the specific target based on the position information of the specific target acquired by the acquisition unit.

37. The image processing device according to claim 1, wherein the server recognizes the signal from the position sensor worn by the specific target and generates position information of the specific target based on the recognition result.

38. The image processing device according to claim 1, further comprising:
an estimation unit configured to estimate a position of a specific player, who is the specific target in a predetermined game, from a pre-set role of the specific player.

39. The image processing device according to claim 38, wherein the estimation unit estimates a position of the specific player also with reference to a role of a reserve player.

40. The image processing device according to claim 38, wherein the estimation unit estimates the position of the specific player based on a result of analysis of a situation of the game.

41. The image processing device according to claim 38, wherein the estimation unit recognizes a player change and estimates the position of the specific player.

42. The image processing device according to claim 1, wherein the control unit can select a mode in which at least one of exposure adjustment and focus adjustment on the specific target is controlled based on the position information of the specific target acquired by the acquisition unit and a mode in which at least one of the adjustments is controlled without being based on the position information of the specific target acquired by the acquisition unit.

43. The image processing device according to claim 1, wherein the control unit can select a mode in which the additional information is displayed when a position of the specific target is outside of the display screen of the display unit and a mode in which the additional information is not displayed.

44. The image processing device according to claim 1,
wherein the specific target is a specific player in a predetermined game, and
wherein the control unit can select the mode in which the additional information is displayed and the mode in which the additional information is not displayed based on a result of analysis of a situation of the game.

45. The image processing device according to claim 13, wherein the control unit can select whether the tracking unit is to be operated if a position of the specific target is outside of the screen of the display unit.

46. The image processing device according to claim 13,
wherein the specific target is a specific player in a predetermined game, and
wherein the control unit can select whether the tracking unit is to be operated based on a situation of the game.

47. An image processing method comprising:
displaying an image;
selecting a specific target from the image displayed in the displaying;
generating specification information of the specific target selected in the selecting;
transmitting the specification information generated in the specification information generating to a server;
acquiring, from the server, position information of the specific target generated by the server based on the specification information; and
controlling at least one of exposure adjustment and focus adjustment of the specific target based on the position information of the specific target acquired in the acquiring.

48. An image processing server comprising,
at least one processor or circuit configured to function as:
a reception unit configured to receive specification information of a specific target sent from an image processing device;
a generation unit configured to search for the specific target from a video based on the specification information received by the reception unit to generate data regarding a position of the specific target and analyze the video and recognize a movement of the specific target to generate a movement recognition result; and
a transmission unit configured to transmit position information of the specific target and information regarding the movement recognition result generated by the generation unit to the image processing device.

49. An image processing server comprising,
at least one processor or circuit configured to function as:
a reception unit configured to receive specification information of a specific target sent from an image processing device;
a generation unit configured to search for the specific target from a video based on the specification information received by the reception unit to generate data regarding a position of the specific target; and
a transmission unit configured to transmit data regarding the position of the specific target generated by the generation unit to the image processing device.

50. A non-transitory computer-readable storage medium configured to store a computer program to execute an image processing method comprising:
displaying an image;
selecting a specific target from the image displayed in the displaying;
generating specification information of the specific target selected in the selecting;
transmitting the specification information generated in the specification information generating to a server;
acquiring, from the server, position information of the specific target generated by the server based on the specification information; and
controlling at least one of exposure adjustment and focus adjustment of the specific target based on the position information of the specific target acquired in the acquiring.

51. A non-transitory computer-readable storage medium configured to store a computer program for controlling an image processing server comprising,
at least one processor or circuit configured to function as:
a reception unit configured to receive specification information of a specific target sent from an image processing device;
a generation unit configured to search for the specific target from a video based on the specification information received by the reception unit to generate data regarding a position of the specific target; and
a transmission unit configured to transmit data regarding the position of the specific target generated by the generation unit to the image processing device.
